(19) United States
(12) Patent Application Publication
(10) Pub. No.: US 2025/0004090 A1
(43) Pub. Date: Jan. 2, 2025

(54) ESTIMATION OF OBSTACLE LOCATION

(71) Applicant: InterDigital Patent Holdings, Inc., Wilmington, DE (US)

(72) Inventors: Fumihiro Hasegawa, Westmount (CA); Kunjan Shah, London (GB); Jaya Rao, Montreal (CA); Tuong Duc Hoang, Montreal (CA); Paul Marinier, Brossard (CA); Moon-il Lee, Melville, NY (US); Janet A. Stern-Berkowitz, Little Neck, NY (US); Benoit Pelletier, Roxboro (CA)

(73) Assignee: InterDigital Patent Holdings, Inc., Wilmington, DE (US)

(21) Appl. No.: 18/702,900

(22) PCT Filed: Oct. 14, 2022
(86) PCT No.: PCT/US2022/046667

§ 371 Date: Apr. 19, 2024

Related U.S. Application Data
(60) Provisional application No. 63/257,420, filed on Oct. 19, 2021.
(60) Provisional application No. 63/335,310, filed on Apr. 27, 2022.
(60) Provisional application No. 63/359,377, filed on Jul. 8, 2022.

(51) Int. Cl. G01S 5/00; G01S 5/02

(52) U.S. Cl. CPC G01S 5/011; G01S 5/0273

(57) ABSTRACT

Systems, methods, and instrumentalities are disclosed herein associated with the estimation of an obstacle location. A WTRU may receive configuration information regarding reference signal (RS) resources, and transmit an RS (e.g., a sounding reference signal for positioning) using a configured resource. The WTRU may receive a signal reflected from an obstacle based on the transmission of the RS and the WTRU may perform a measurement of the reflected signal. The WTRU may report a result of the measurement to a network device to assist the network device with determining the location of the obstacle.

### CROSS-REFERENCE TO RELATED APPLICATIONS

This application claims the benefit of Provisional U.S. Patent Application No. 63/257,420, filed Oct. 19, 2021, Provisional U.S. Patent Application No. 63/335,310, filed Apr. 27, 2022, and Provisional U.S. Patent Application No. 63/359,377, filed Jul. 8, 2022, the disclosure of which are incorporated herein by reference in their entireties.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE). Wireless communication devices may establish communications with other devices and data networks, e.g., via an access network, such as a radio access network (RAN).

### SUMMARY

Described herein are systems, methods, and instrumentalities associated with the estimation of an obstacle location. A wireless transmit receive unit (WTRU) as described herein may comprise a processor configured to receive configuration information, wherein the configuration information may indicate a first group of resources. The processor may be further configured to transmit a first sounding reference signal for positioning (SRSp) using a first resource from the first group of resources, and, in response to receiving a first reflected signal based on the transmission of the first SRSp, perform a first measurement of the first reflected signal. If a result of the first measurement meets a first condition, the processor may be further configured to report the result of the first measurement to a network device.

In examples, the configuration information may further indicate a second group of resources and a relationship between the first resource and one or more resources from the second group of resources. Based on the determination that the result of the first measurement meets the condition, the processor of the WTRU may be further configured to select a second resource from the second group of resources based on the first resource used to transmit the first SRSp and the relationship between the first resource and the one or more resources from the second group of resources, and transmit a second SRSp using the second resource selected from the second group of resources. In response to receiving a second reflected signal based on the transmission of the second SRSp, the processor may be further configured to perform a second measurement of the second SRSp. If a result of the second measurement meets a second condition, the processor may report the result of the second measurement to the network device. The second measurement may include a reference signal received power (RSRP) measurement associated with the second reflected signal, and the result of the second measurement may be determined to meet the second condition based on a determination that the RSRP measurement exceeds a threshold value. The processor may be further configured to determine a time delay between the transmission of the second SRSp and the reception of the second reflected signal, and report the time delay to the network device.

In examples, the first group of resources may be associated with SRSp transmissions and beams of a first beamwidth, the second group of resources may be associated with SRSp transmissions and beams of a second beamwidth, and the first beamwidth may be wider than the second beamwidth. In examples, the first measurement may include a reference signal received power (RSRP) measurement, and the result of the first measurement may be determined to meet the first condition based on a determination that the RSRP measurement exceeds a threshold value. In examples, the processor may be further configured to determine a time delay between the transmission of the first SRSp and the reception of the first reflected signal, and to report the time delay to the network device.

In examples, the processor may be further configured to receive a positioning reference signal (PRS) from the network device, determine whether a second resource from the first group of resources is spatially aligned with the PRS, and, based on a determination that no resource from the first group of resources is spatially aligned with the PRS, send a request to the network device for an SRSp resource that is spatially aligned with the PRS. Whether the second resource is spatially aligned with the PRS may be determined based on an angle of arrival of the PRS and a boresight angle of the second resource.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 shows an example of detecting an object based on the difference between an expected angle of arrival (AoA) and a measured AoA.

FIG. 3 shows an example of detecting an obstacle and a round trip time (RTT).

FIG. 4 shows an example of RTT determination.

FIG. 5 shows an example of obstacle positioning based on an uplink angle of arrival (UL-AoA).

FIG. 6 shows an example of a Time Division Duplex (TDD) configuration for an active WTRU.

FIG. 7 shows an example of a TDD configuration for a non-active WTRU.

FIG. 8 shows an example of a WTRU transmitting an SRSp to an obstacle and making measurement(s) related to the transmitted SRSp.

FIG. 9 shows an example of a WTRU transmitting SRSps in different directions.

FIG. 10 shows examples of a timeline of SRSp transmission and reception based on a TDD configuration.

FIG. 11 shows an example of a measurement gap.

FIG. 12 shows an example of using different groups of SRSp beams for obstacle detection, where SRSp2-1, SRSp2-2 and SRSp2-3 in a second set may be spatially aligned or related with SRSp2 in a first set.

FIG. 13 shows an example of estimating the positions of more than one obstacle.

FIG. 14 shows an example of obstacle detection based on more than one group of beams.

FIG. 15 shows an example of a TDD configuration that may include sensing and communication durations.

FIG. 16 shows an example of a TDD configuration.

FIG. 17 shows an example of a TDD slot with a mixture of half-slots and full-slots.

FIG. 18 shows an example of durations in a TDD configuration associated with SRSp resources.

FIG. 19 shows an example of detecting the presence of an obstacle.

FIG. 20 shows an example of an association between a primary obstacle location and one or more relative (e.g., differential) positions.

### DETAILED DESCRIPTION

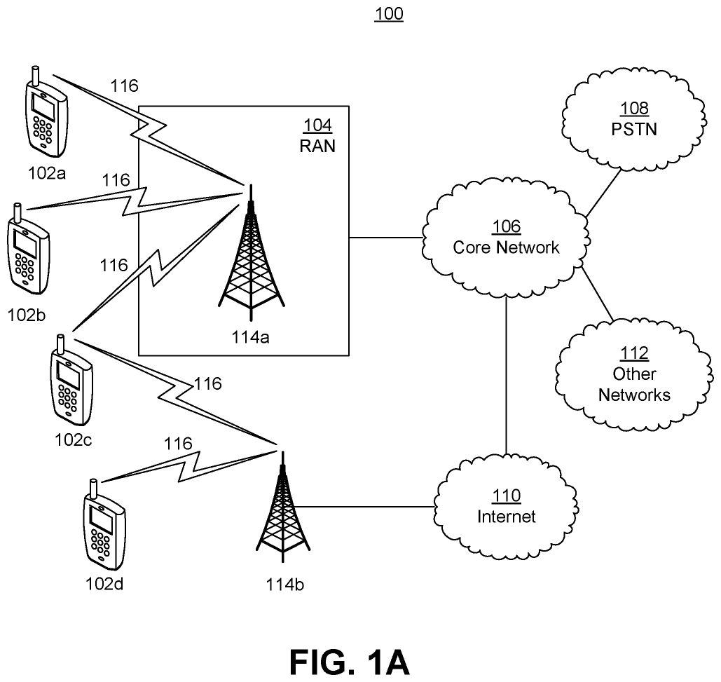

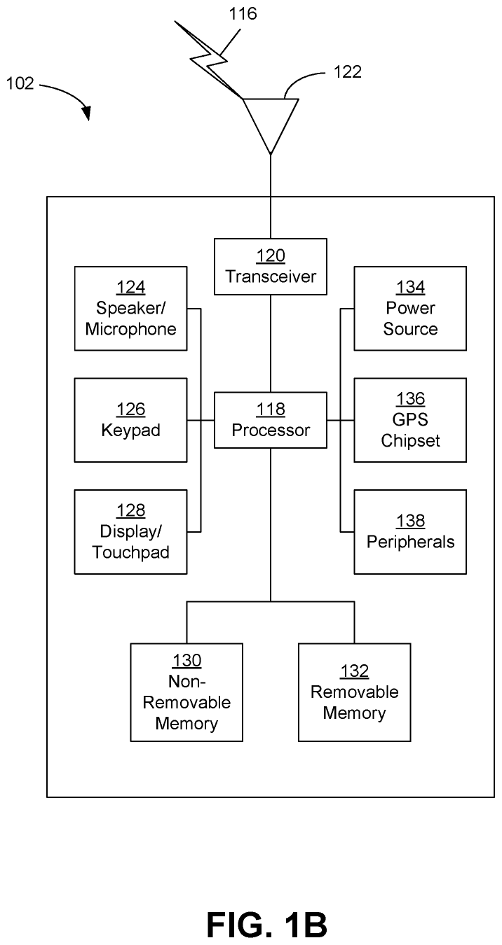

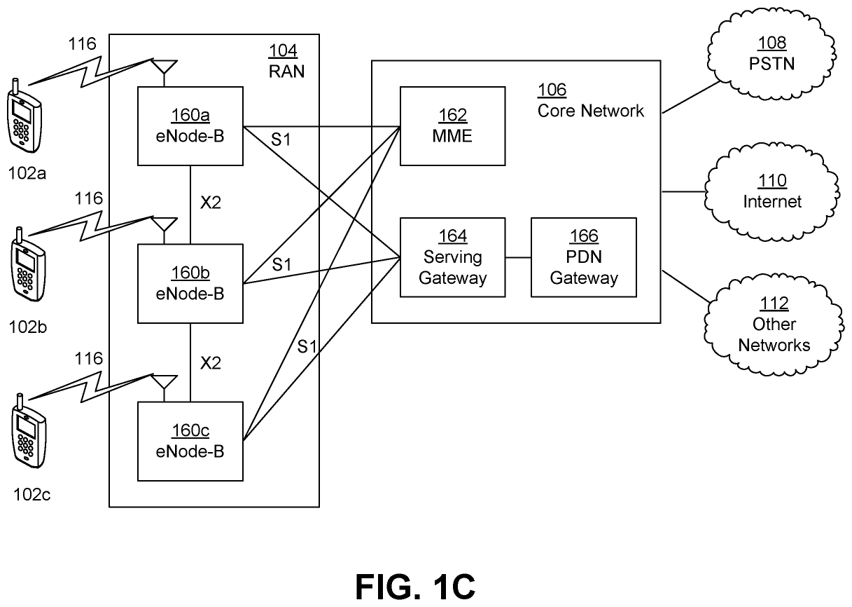

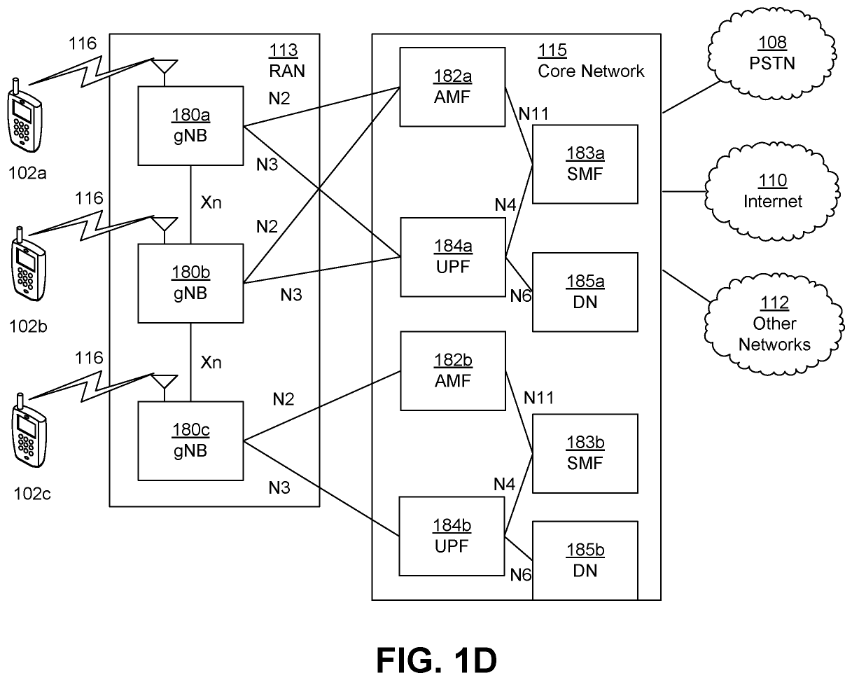

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an encode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to a time, a time period, tracking the time, tracking the period of time, etc. Reference to a timer expiration herein may refer to determining that the time has occurred or that the period of time has expired. Downlink (DL), uplink (UL), and/or downlink and uplink positioning operations may be used for WTRU positioning. The positioning may be conducted using one or more of a positioning reference signal (PRS), a sounding reference signal (SRS), and/or a sounding reference signal for positioning (SRSp) purposes. The terms “resource” and “beam” may be used interchangeably herein. The terms “SRS” and “SRSp” may be used interchangeably herein. The terms “ID” and “index” may be used interchangeably herein.

An obstacle (e.g., a moving truck) may randomly block the path between a WTRU and a transmission-reception point (TRP) such as a base station, which may result in blocking the line of sight (LOS) path between the WTRU and the TRP, lowering the reference signal received power (RSRP) of a reference signal, and/or degrading the quality of communication and accuracy of positioning. A network (e.g., a base station) and/or the WTRU may benefit from knowing the position of the obstacle. The network and/or the WTRU may engage in resource allocation based on the position of the obstacle and/or to avoid the obstacle, for example.

A procedure for estimation of an obstacle location may be described herein. A WTRU may send capability information to the network, where, for example, the capability information may indicate obstacle positioning capability (e.g., DL/UL-based or round trip time (RTT)-based positioning capability) of the WTRU. The WTRU may receive configuration information regarding DL-RS resources and/or one or more monitoring (e.g., for reference signals) configurations. The WTRU may determine to activate obstacle positioning, for example, if one or more activation conditions are satisfied. The WTRU may perform obstacle positioning (e.g., send reports such as measurement reports for monitored PRS resources to the network and/or transmit an SRSp) based on configuration information related to a positioning operation and/or associated conditions. The WTRU may terminate obstacle positioning if one or more termination conditions are satisfied.

In examples, positioning operations may be performed by the WTRU and/or the network, e.g., in the downlink, and/or uplink. One or more of the following may apply. A DL positioning operation may include a (e.g., any) positioning operation that uses a downlink reference signal such as a PRS. For example, the WTRU may receive multiple reference signals from one or more transport points (TPs) and may measure a DL reference signal time difference (RSTD) and/or an RSRP associated with the reference signals. In examples, the DL positioning operations may include DL-angle of departure (AoD) or DL-time difference of arrival (TDOA) positioning. A UL positioning operation may include a positioning operation (e.g., any positioning operation) that uses an uplink reference signal such as an SRSp. The WTRU may transmit an SRSp to multiple reception points (RPs) and the RPs may measure a UL relative time of arrival (RTOA) and/or an RSRP associated with the SRSp. In examples, the UL positioning operation may include UL-TDOA or UL-angle of arrival (AoA) positioning. A DL and UL positioning operation may include a positioning operation (e.g., any positioning operation) that uses both uplink and downlink reference signals for positioning. In examples, the WTRU may transmit an SRSp to multiple TRPs and the network (e.g., a gNB) may measure an Rx-Tx time difference associated with the SRSp. For instance, the network may measure an RSRP for the received SRS. The WTRU may measure an Rx-Tx time difference for a PRS transmitted from a TRP. The WTRU may measure an RSRP for the received PRS. The Rx-TX difference and/or the RSRP measured at the WTRU and/or the gNB may be used to compute a round trip time (RTT). The Rx-Tx difference may refer to the difference between the arrival time of a reference signal transmitted by the TRP and the transmission time of a reference signal transmitted from the WTRU. In examples, a DL and UL positioning operation may include multi-RTT positioning (e.g., positioning based on respective RTTs between the WTRU and multiple TRPs).

As used herein, a network may include an AMF, a location management function (LMF), or a next generation radio access network (NG-RAN). The terms “pre-configuration” and “configuration” may be used interchangeably herein. The terms “non-serving gNB” and “neighboring gNB” may be used interchangeably herein. The terms “gNB” and “TRP” may be used interchangeably herein. The terms “PRS” and “PRS resource” may be used interchangeably herein. As used herein, positioning reference signals and PRS resources may be associated with different PRS resource sets. The terms “PRS,” “DL-PRS,” and “DL PRS” may be used interchangeably herein. The terms “measurement gap” and “measurement gap pattern” may be used interchangeably herein. A measurement gap pattern may include parameters such as a measurement gap duration, a measurement gap repetition period, and/or a measurement gap periodicity.

A positioning reference unit (PRU) may include a WTRU or a TRP whose location (e.g., altitude, latitude, geographic coordinate, and/or local coordinate) may be known by the network (e.g., gNB, LMF, and/or the like). The capabilities of a PRU may be same as a WTRU or TRP (e.g., capable of receiving a PRS, transmitting an SRS or SRSp, performing and/or reporting measurements, or transmitting a PRS). A WTRU acting as a PRU may be used by the network for calibration (e.g., correct unknown timing offset, correct unknown angle offset, etc.). An LMF may be an example of a node or entity (e.g., network node or entity) that may be used for or to support positioning. In examples, an LMF may be substituted with another node or entity.

An obstacle (e.g., a moving truck) may randomly block the path between a WTRU and a TRP, which may block the LOS path between the WTRU and the TRP, lowering the RSRP of a reference signal, and/or degrading communication and positioning quality. The position of the obstacle may be determined by the network and/or the WTRU, for example, such that resource allocation may be conducted to avoid the obstacle.

A procedure for an obstacle positioning operation may be provided. A WTRU or PRU (e.g., that may perform measurements (e.g., on a reference signal such as an SRSp or a PRS) and/or send measurement reports or UL-RS(s) to a TRP (e.g., LMF, gNB, and/or the like)) may be referred to as an active WTRU. The active WTRU may send capability information to the network indicating obstacle positioning capabilities (e.g., DL/UL-based or RTT-based positioning) of the WTRU. The active WTRU may receive configuration information regarding DL-RS resources and/or monitoring configurations. The active WTRU may determine to activate obstacle positioning (e.g., obstacle position determination), for example, if one or more activation conditions are satisfied. The active WTRU may perform obstacle positioning (e.g., send measurement reports for one or more monitored PRS resources to the network or send an SRS for positioning) based on a configured positioning method and associated conditions. The active WTRU may terminate the obstacle positioning, for example, if one or more termination conditions are satisfied.

The capability information described herein may include the capability of the active WTRU to function as a PRU. The active WTRU may send its location information to the network, for example, if the network requests the location information. The active WTRU may provide its location to the network, for example, if requested by the network.

The active WTRU may receive assistance information for a DL/UL RS associated with other WTRUs. These other WTRUs may refer to PRUs or WTRUs that are not the active WTRU, which may be referred to as non-active WTRUs. In examples, one or more of these non-active WTRUs may be active WTRUs themselves such that they may monitor PRSs intended for other WTRUs. For example, if there are three WTRUs in the network (e.g., WTRU1, WTRU2, and WTRU3, WTRU1 may monitor PRS resources configured for WTRU2 and WTRU3, while WTRU2 may monitor PRS resources configured for WTRU1 and WTRU3. The active WTRU may receive configuration information regarding a UL RS transmitted by other WTRUs, for example, so that the active WTRU may monitor a UL RS transmitted by the other WTRUs.

Common DL/UL RS parameters may be configured. For example, the active WTRU may receive parameters as described herein that may be common for obstacle positioning operations. The parameters may include respective locations of the non-active WTRUs/TRPs, which may be the intended recipients of a DL-RS/UL-RS. The parameters include a WTRU ID (e.g., TRP ID, ID associated with a PRU, or ID of an intended recipient of the DL-RS). The parameter may include an LOS/NLOS indicator associated with a DL/UL RS resource or a TRP ID with respect to an intended recipient (e.g., non-active WTRU or TRP) of the DL/UL RS. For example, the LOS indicator may have a value between 0 and 1, and may indicate a likelihood of the presence of an LOS between the TRP and the non-active WTRU or along an associated PRS resource. For example, if the LOS indicator associated with a PRS resource is set to 1, it may indicate a high likelihood that the PRS transmitted on the PRS resource goes through the LOS path.

Activation conditions may be provided and/or used for obstacle positioning. The active WTRU may determine to initiate obstacle positioning, for example, if one or more of the following conditions are satisfied. A condition may be met if the RSRP of an indicated DL RS (e.g., PRS, channel state indicator reference signal (CSI-RS), Synchronization Signal Block (SSB), demodulation reference signal (DM-RS), phase tracking reference signal (PT-RS), etc.) is below a preconfigured threshold. For example, if the RSRP of the indicated DL RS is below the threshold, the active WTRU may determine that obstacle positioning is initiated. The active WTRU may receive an indication from the network on which DL RS resources to monitor. A condition may be met if the measurement (e.g., measurement results) of multiple paths (e.g., multiple time of arrivals, multiple angle of arrivals, etc.) associated with a channel meets certain criteria. A condition may be met if an explicit indication is received from the network to estimate the position of an obstacle. For example, the active WTRU may receive such an indication for a WTRU-specific channel (e.g., PDSCH or PDCCH) or a broadcast channel (e.g., for SIB). As another example, the active WTRU may receive the explicit indication from a gNB or LMF via downlink control information (DCI), a medium access control element (MAC-CE), radio resource control (RRC) signaling, an LTE positioning protocol (LPP) message, etc. As yet another example, the active WTRU may receive the explicit indication from the network if the RSRP of a UL-RS such as an SRSp is below a threshold. A condition may be met if a change in an RSRP exceeds a preconfigured threshold. For example, the active WTRU may report an RSRP for a PRS of X dBm during the last measurement reporting occasion and of Y dBm during the current measurement reporting occasion. If X-Y is greater than the preconfigured threshold, the active WTRU may determine that obstacle positioning is initiated. A condition may be met if a preconfigured time for obstacle positioning arrives. For example, the active WTRU may receive timing information related to the start and/or end of obstacle positioning including, e.g., a relative time with respect to a reference time, a time offset from the reception of an indication, signal, or channel from the network, etc.

In examples, PRS and/or SRSp parameters may be provided. A PRS resource configuration may include one or more of the following: a PRS resource ID, a PRS sequence ID (or other IDs used to generate a PRS sequence), a PRS resource element offset, a PRS resource slot offset, a PRS symbol offset, PRS Quasi Co Location (QCL) information, a PRS resource set ID, a list of PRS resources in a resource set, a number of PRS symbols, a muting pattern for PRS and/or muting parameters such as a repetition factor and/or muting options, a PRS resource power, a periodicity of a PRS transmission, spatial direction information of a PRS transmission (e.g., beam information and/or angles of transmission), spatial direction information of an UL RS reception (e.g., a beam ID used to receive an UL RS and/or angle of arrival), a frequency layer ID, a TRP ID, or a PRS ID.

An SRSp or SRS resources configuration may include one or more of the following, a resource ID, comb offset values and/or cyclic shift values, a start position in the frequency domain, a number of SRSp symbols, a shift in the frequency domain for an SRSp, a frequency hopping pattern, a type of SRSp (e.g., aperiodic, semi-persistent or periodic), a sequence ID used to generate an SRSp or other IDs used to generate an SRSp sequence, spatial relation information indicating which reference signal (e.g., DL RS, UL RS, CSI-RS, SRS, DM-RS, etc.) or SSB (e.g., SSB ID and/or cell ID of the SSB) the SRSp is related to spatially, QCL information (e.g., a QCL relationship between SRSp and other reference signals or SSB), a QCL type (e.g., QCL type A, QCL type B, and/or QCL type D), a resource set ID, a list of SRSp resources in a resource set, transmission power related information, pathloss reference information which may include an index for SSB, CSI-RS or PRS, a periodicity of SRSp transmission, or spatial information such as spatial direction information of an SRSp transmission (e.g., beam information and/or angles of transmission), spatial direction information of a DL RS reception (e.g., beam ID used to receive DL RS and/or angle of arrival), etc. In examples, a comb pattern for SRSp may place an SRSp in every other resource element or subcarrier in the frequency domain, e.g., which may be known as a comb-2 pattern. A comb offset may depend on a comb value. For example, for the comb-2 pattern, comb offset values may include 0 and 1. For a comb-4 pattern, comb offset values may include 0, 1, 2, and 3. In examples (e.g., in a comb-4 pattern), an SRSp may be placed in every 4 resource elements or subcarriers.

Monitoring configurations (e.g., related to the monitoring of reference signals) may be provided. A active WTRU may receive monitoring configurations from the network, for example, regarding DL/UL-RS resources. For example, configuration parameters for a monitoring occasion may include one or more of the following. The configuration parameters for a monitoring occasion may include the RS resources to monitor (e.g., a whole set or subset of the configured RS resources). For example, the active WTRU may receive an explicit indication from the network to report a subset of PRS/SRSp resources. The active WTRU may determine to select PRS/SRSp resources to monitor based on assistance information configured by the network. For example, the active WTRU may receive an indication from the network to select PRS/SRSp resources based on the LOS or NLOS indicator associated with the PRS/SRSp resource or TRP. The active WTRU may determine to monitor PRS resources with associated indicators below a preconfigured threshold. Choosing PRS resources with a higher likelihood for NLOS may increase the likelihood for the active WTRU to detect an obstacle.

The configuration parameters for a monitoring occasion may include a monitoring time window (e.g., start and end time of monitoring expressed in terms of symbol number, frame number, slot number, and/or PRS resource). For example, the active WTRU may determine a duration of a time window based on a duration of the PRS resource that the active WTRU monitors. The active WTRU may be configured with multiple time windows corresponding to multiple RS resources that the active WTRU is configured to monitor.

The configuration parameters for a monitoring occasion may include a monitoring periodicity (e.g., in terms of number of symbols, slots, subframes, and/or frames). For example, the active WTRU may determine a periodicity of a monitoring window which may be aligned with the periodicity of a PRS resource. The configuration parameters for a monitoring occasion may include measurement gap configurations. During a measurement gap that the active WTRU may not expect to receive data or control channels, the active WTRU may assume that the monitoring time window is associated with the measurement gap. An LMF may indicate to a gNB the configuration for the monitoring window, and the gNB may schedule a measurement gap to align with the monitoring window. In such a case, the active WTRU may not send a request to the network to configure a measurement gap. If the monitoring window is not configured, the active WTRU may send a request to the network (e.g., gNB, LMF, and/or the like) for configuration of a measurement gap to receive a DL-RS (e.g., PRS). During a measurement gap, the active WTRU may not receive data or control channels (e.g., PDCCH, PDSCH, and/or the like). In such a case, the WTRU may make measurements on and/or monitor signals transmitted by TRPs or non-active WTRUs. For example, the active WTRU may send a request via uplink control information (UCI), a MAC-CE, RRC signaling, or an LPP message. The active WTRU may receive configuration information for a measurement gap where the gap may be configured at a periodicity that is aligned with the periodicity of DL-RS resource(s) that the active WTRU is monitoring. A duration of the measurement gap (e.g., each period of the measurement gap) may be long enough to cover one period of a periodically transmitted DL-RS. If the monitoring window is not configured, the active WTRU may receive an indication from the network that the active WTRU does not need a measurement gap associated with the monitoring of PRS.

WTRU behaviors may be associated with a power saving mode. An active WTRU may enter a power saving mode, for example, if the WTRU determines that an obstacle does not exist. The condition(s) based on which the WTRU may determine to enter the power saving mode may be positioning operation-specific as described herein. While in the power saving mode, the active WTRU may monitor for an indication from the network to initiate monitoring of a DL-RS and/or an UL-RS. The active WTRU may, for example, receive configuration information from the network at a time and/or frequency location allocated for a channel or a signal, and the configuration information may include an indicator (e.g., a trigger) for the WTRU to start monitoring for the DL-RS and/or UL-RS. The indicator may be included in a periodically transmitted signal or channel (e.g., transmitted by a TRP), and the WTRU may receive information regarding the time and/or frequency location, periodicity, and/or duration of the signal or channel from the network. The indicator may be transmitted via broadcast signaling or WTRU-specific signaling. For broadcast signaling, the active WTRU may be configured with a search space (e.g., time and frequency resources) which may dedicated to indicate the initiation of reference signal (e.g., PRS) monitoring. During the power saving mode, the active WTRU may reset timer(s) or counters configured for the WTRU.

Termination condition(s) may be provided and/or used for obstacle positioning. The active WTRU may determine to terminate obstacle positioning, for example, if one or more of the following conditions are satisfied. A condition for terminating obstacle positioning may be deemed satisfied based on a timer expiration. For example, the active WTRU may receive configuration information related to a duration in which the active WTRU may perform obstacle positioning. The active WTRU may start a timer once the active WTRU begins obstacle positioning. Based on expiration of the timer, the active WTRU may return an indication to the network (e.g., LMF, gNB, and/or the like) that the active WTRU has terminated the obstacle positioning. A condition for terminating obstacle positioning may be deemed satisfied if no obstacle is detected for a preconfigured duration. A condition for terminating obstacle positioning may be deemed satisfied if one or more reporting conditions is not satisfied (e.g., if none of the reporting conditions are satisfied) for a preconfigured number of occasions (e.g., consecutively). A condition for terminating obstacle positioning may be deemed satisfied if the active WTRU receives an explicit indication from the network (e.g., LMF, gNB, and/or the like) to terminate the obstacle positioning. A condition for terminating obstacle positioning may be deemed satisfied based on a number of measurement reports transmitted. For example, the active WTRU may determine to terminate the obstacle positioning once the active WTRU sends a preconfigured number of measurement reports to the network.

PRU-assisted estimation of an obstacle location may be conducted. In examples, an active WTRU or PRU may monitor for PRS(s) intended for other WTRUs or PRUs, and may report measurements to the network (e.g., LMF) regarding the PRS(s), for example, if the measurements satisfy one or more conditions. Measurements for multiple PRS(s) may be reported to the network (e.g., LMF) to assist the network to determine the size or dimension of the obstacle. In one or more of the examples provided herein, a WTRU may be assumed to be an active WTRU.

A non-active WTRU may receive configuration information regarding a PRS (e.g., a number of PRS symbols, a repetition factor, a frequency allocation, a bandwidth, the comb factor of a PRS, a PRS resource ID, a PRS ID, a periodicity, the start and end of a semi-persistent DL RS transmission, a TRP ID, etc.). The non-active WTRU may be configured with a monitoring window during which the non-active WTRU may receive a PRS transmitted from a TRP. The non-active WTRU may receive an indication to make measurements on configured PRS resources and report the measurements to the network (e.g., LMF, gNB, and/or the like). The non-active WTRU may terminate the monitoring of the configured PRS resources once the monitoring window duration expires or if the non-active WTRU receives an explicit indication from the network to terminate the monitoring.

An active WTRU may receive assistance information for a PRS or other DL RS associated with one or more non-active WTRUs, e.g., via an LPP or RRC message. For example, the active WTRU may receive configuration information regarding one or more of the following pieces of assistance information related to a non-active WTRU: information related to a DL RS resource (e.g., a number of PRS symbols, a repetition factor, a frequency allocation, a bandwidth, a comb factor of a PRS, a PRS resource ID, a PRS ID, a periodicity, the start and end of a semi-persistent DL-RS transmission, etc.), an RS resource set ID (e.g., PRS resource set ID), transmission parameters for an RS (e.g., periodicity of PRS transmission, muting pattern for PRS, or comb pattern of PRS), boresight angles of transmitted reference signals (e.g., PRSes), an expected AoD of a DL RS (e.g., PRS) at a TRP, a range of AoD (e.g., minimum and maximum values of the AoD, and/or lower and upper bounds of the AoD), an expected AoA of a DL RS (e.g,. PRS) at an intended PRU/WTRU (e.g., minimum and maximum values of the AoA, and/or lower and upper bounds of the AoA), the location of the TRP(s) from which the PRS(s) may be transmitted from, and/or certain threshold(s) (e.g., threshold(s) used by the active WTRU to determine whether to include measurements in a report, whether to terminate obstacle positioning, or whether send a report to the network). The assistance information may be provided by the network (e.g., LMF, gNB, and/or the like) via LPP, RRC, or broadcast signaling.

The active WTRU may send a report to the network, where the report may include one or more of the following measurements, and a PRS may be used as an example of a DL-RS. The report may include the RSRP of a PRS received via a configured PRS resource. The active WTRU may store RSRP measurements per measurement occasion (e.g., for each PRS resource during periodic PRS transmissions of one measurement duration), and may report the stored RSRP measurements. In examples, the active WTRU may process one or more RSRP measurements (e.g., calculate an average of multiple RSRP measurements) during one measurement duration and may send the processed RSRP measurements to the network. The report may include a PRS ID associated with a measured PRS. The report may include a WTRU ID which may be the intended recipient of the PRS whose measurements are reported by the active WTRU. The report may include a PRS resource ID for the measured PRS. The report may include a transmission source ID (e.g., TRP ID or cell ID) from which the measured PRS may be transmitted. The report may include the time of arrival of a PRS RSTD with respect to a configured reference PRS (e.g., or reference TRP). The report may include an AoA. The report may include an estimated AoD at a TRP (e.g., the estimated AoD may be determined by the active WTRU based on an angle of arrival). The report may include one or more Rx beam indices used to receive the PRS Panel ID(s) of one or more panels used to receive PRS(s). The WTRU may send the report to the network via an LPP message, RRC signaling, or a PUSCH transmission.

The active WTRU may receive configuration information from the network regarding a report. For example, the WTRU may receive one or more of the following parameters: reporting periodicities (e.g., reporting occasions scheduled at configured intervals such as in terms of slots, symbols, frames, subframes, or time such as 5 ms or 10 ms), the starting time of a report, the maximum number of PRS resources to report, the ID(s) of one or more PRS resources (e.g., the active WTRU may be configured to report measurements of specific PRS resources indicated by the network), the ID(s) of one or more WTRUs who may be intended to receive a PRS (e.g., the active WTRU may be configured to report measurements of PRS(s) intended for one or more specific WTRUs), or whether to report an RSRP, an RSTD, a ToA, an AoA, an AoD, an estimated AoD and/or translated AoA (e.g., where the translated AoA may be determined based on the location of a TRP, the location of an intended non-active WTRU, and/or the boresight angle of a PRS transmitted from a TRP to an intended non-active WTRU).

One or more conditions for reporting may be provided. The active WTRU may determine to send a report with the measurements described herein, for example, if one or more of the following reporting conditions are satisfied: the RSRP of a PRS associated with a non-active WTRUs is above a threshold, the difference between an angle of arrival of a PRS associated with a non-active WTRUs and the expected AoA at an intended WTRU is above a threshold, or a difference between an angle of arrival of a PRS and a translated angle of arrival based on the boresight direction of the PRS is above a threshold (e.g., the translated angle of arrival may be determined based on the boresight direction of the PRS, location of the transmission source such as a TRP, and/or the location of the intended recipient such as a non-active WTRU).

If one or more of the above conditions are not satisfied (e.g., if none of the above conditions are satisfied), the active WTRU may perform one or more of the following. The active WTRU may not send a measurement report to the network at a measurement reporting occasion. The active WTRU may request the network to send a PRS from different TRPs intended for different non-active WTRUs. The active WTRU may determine to send the request, for example, if none of the conditions is satisfied for a preconfigured number of occasions (e.g., consecutively). The active WTRU may enter a power saving mode (e.g., the active WTRU may not perform reference signal measurements), during which the active WTRU may initiate obstacle positioning in response to receiving an indication from the network. For example, the active WTRU may receive a threshold from the network, and may determine to enter the power saving mode if the number of occasions (e.g., consecutive occasions) at which none of the reporting conditions is satisfied is above the threshold.

The active WTRU may be configured with priorities for one or more of the conditions described herein. For example, the WTRU may be configured with two thresholds (e.g., a first threshold and a second threshold for angle difference and RSRP, respectively). The WTRU may receive an indication from the network (e.g., LMF, gNB, and/or the like) that the priority level of the first threshold is higher than that of the second threshold. The active WTRU may determine to not send a measurement report (e.g., cancel the transmission of a report) if the detected angle difference is less than the first threshold even if the RSRP of the received PRS is above the second threshold.

The active WTRU may receive configuration information regarding a PRS from the network. The active WTRU may determine to initiate obstacle positioning, for example, if the RSRP of the configured PRS is below a threshold. The active WTRU may request assistance information from the network. The active WTRU may receive assistance information from the network (e.g., LMF) for a PRS associated with one or more intended recipients (e.g., non-active WTRUs), where the assistance information may include angle information (e.g., an expected AoD or boresight). The active WTRU may receive an LOS indicator, a time offset T, and/or a monitoring duration associated with the PRS. The active WTRU may receive an indication and/or a threshold from the network to select a subset of PRS resources based on the LOS indicator. The active WTRU may determine a subset of PRS resources to monitor based on the LOS indicator (e.g., the WTRU may monitor PRS resources having an LOS indicator value less than the threshold). At T time units (e.g., seconds) after the active WTRU receives the assistance information, the active WTRU may initiate obstacle positioning.

The active WTRU may receive a PRS intended for one or more non-active WTRUs. Based on the active WTRU receiving the PRS intended for the non-active WTRUs, one or more of the following may apply. The active WTRU may send a measurement report for the PRS to the network (e.g., LMF), for example, if the active WTRU detects one or more of the following: the difference between the received angle of the PRS and certain angle value (e.g., a translated AoA determined based on assistance information) is above a preconfigured angle threshold, or the RSRP of the received PRS is above a preconfigured RSRP threshold. If the angle difference for the PRS is below the angle threshold or the RSRP of the received PRS is below the RSRP threshold, the active WTRU may not send a measurement report corresponding to the PRS. If the active WTRU does not send measurement reports for a duration longer than a threshold, the active WTRU may send a request to the network to configure one or more different sets of PRS resources for monitoring, and, once configured, the WTRU may monitor those sets of PRS resources. The active WTRU may receive a PRS intended for one or more non-active WTRUs as described herein. After the monitoring duration, the active WTRU may terminate the obstacle positioning.

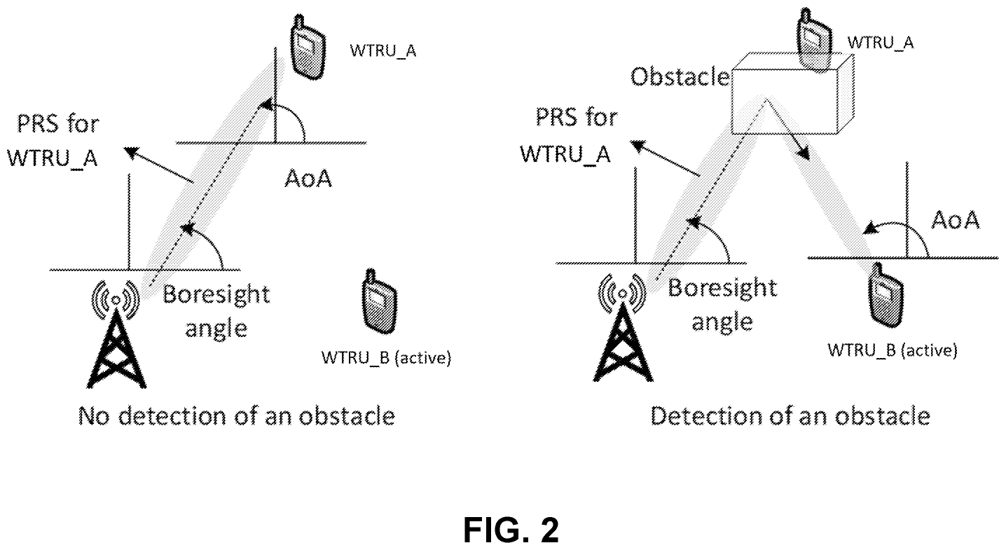

FIG. 2 shows an example of detection of an object (e.g., an obstacle) based on the difference between an expected AoA and an actual AoA. The left side of FIG. 2 shows an environment with no obstacle. In such an environment, WTRU_B, which may be an active WTRU, may not detect a PRS intended for WTRU_A (e.g., the intended recipient of the PRS). In the presence of an obstacle, as shown in the right side of FIG. 2, the WTRU_B may receive the PRS intended for WTRU_A (e.g., due to reflection). In such a case, there may be a difference between an expected AoA at WTRU_A (e.g., the AoA illustrated on the left side of FIG. 2) and a measured AoA at WTRU_B (e.g., the AoA illustrated on the right side of the FIG. 2). Due to the possibility of the presence of the obstacle, WTRU_B may report one or more measurements associated with the PRS to the network (e.g., LMF).

An active WTRU may report the measurements described herein for multiple PRS resources and may associate the measurements with the same ID and include the ID in the report for the network. Grouping measurements corresponding to multiple PRS resources may indicate to the network that the measurements are associated with the same obstacle, which may enable the network to determine the dimensions of the obstacle. The ID may be considered as an identifier for the obstacle.

Conditions based on which the active WTRU may associate multiple measurements with the same group ID may be provided. For example, the active WTRU may determine to group the measurements and associate them with a group ID if at least one of the following conditions is satisfied. The active WTRU may group multiple measurements if an AoA or translated AoA for each PRS resource in the group is within a preconfigured range. The active WTRU may group multiple measurements if the relative time of arrivals (e.g., difference in time of arrivals between two received PRSs) is below a preconfigured threshold. For example, the active WTRU may determine the PRS that arrived first and measure its time of arrival. Based on the first PRS, the active WTRU may determine the relative times of arrival for one or more PRS's that arrive later than the first PRS. The active WTRU may group those PRS's (e.g., PRS resources or PRS resource IDs) whose associated relative time is below the preconfigured threshold.

On-demand obstacle positioning may be performed. The active WTRU may send a request to the network (e.g., LMF, gNB, and/or the like) to change a PRS beam (e.g., a PRS resource) for monitoring, for example, to improve the accuracy of the obstacle estimation. The active WTRU may send the request based on one or more of the following conditions. The active WTRU may obtain more than one AoA or more than one time of arrival for a PRS that the active WTRU is configured to monitor (e.g., the active WTRU may be configured to observe a multi-path channel). The active WTRU may send a request to the network (e.g., to send a different PRS), for example, if the number of observed AoAs or times of arrival for the PRS is above a preconfigured threshold, if the RSRP of the received PRS is below a preconfigured threshold, etc. The content of the request may include one or more of the following: a number of PRSs or PRS resources (e.g., the active WTRU may request more PRSs to reflect off the obstacle so as to collect more measurements), boresight angles (e.g., the active WTRU may request PRSs to be transmitted at specific angles), the ID(s) of intended WTRU(s) or PRU(s) (e.g., the active WTRU may have knowledge of other non-active WTRUs configured by the network at the active WTRU's request, and the active WTRU may request the network to configure PRS(s) such that the PRS(s) may be transmitted toward the intended WTRUs that the active WTRU requested), or QCL information (e.g., the active WTRU may indicate a QCL-D source where the source may be co-located with another PRS and the QCL-D source may be a CSI-RS or SSB).

The active WTRU may receive one or more of the following configuration information from the network, e.g., based on the active WTRU sending the request to the network: information about PRS resources or PRS resource IDs, where the number of the resources may match the number of PRSs the active WTRU requested, information about PRS resource(s) with the boresight angle(s) that the active WTRU requested, or information about PRS resource(s) transmitted toward the non-active WTRU(s) with the IDs that the active WTRU requested.

The position of an obstacle may be estimated based on an RTT. In examples, the active WTRU may receive a PRS and may transmit an uplink reference signal (UL-RS) to locate an obstacle. The UL-RS may be assumed to be an SRSp, but those skilled in the art will appreciate that the UL-RS may not be limited to an SRSp and may be any reference signal used in the UL such as an SRS, a DM-RS, a PT-RS, etc.

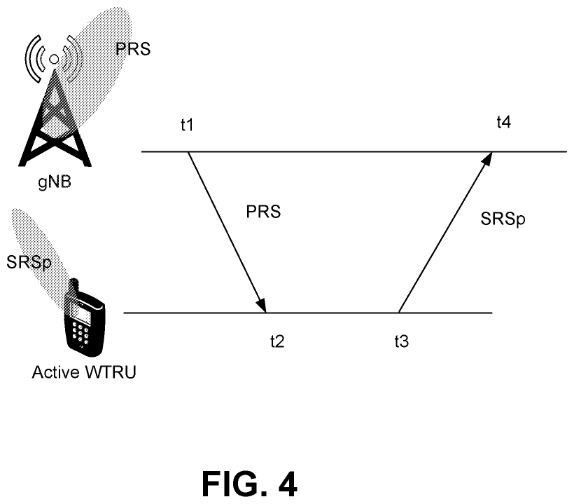

The network (e.g., LMF) may provide assistance information for obstacle positioning. The active WTRU may (e.g., based on receiving an indication to perform obstacle positioning such as RTT-based positioning) receive one or more of the following configuration information from the network (e.g., gNB, LMF, and/or the like). The configuration information may include information related to DL-RS resources such as a number of PRS symbols, a repetition factor, a frequency allocation, a bandwidth, a comb factor of a PRS, a PRS resource ID, a PRS ID, a periodicity, start and/or end time for a PRS transmission, etc. The configuration information may include a gNB Tx-Rx time (e.g., difference between the reception time of an SRSp and the transmission time of a PRS, where the SRSp may be associated with an SRSp resource ID configured for one or more non-active WTRUs, which may a recipient of the PRS transmitted by the gNB). The PRS resource ID may be one of the PRS resource IDs that the active WTRU may be configured to monitor. FIG. 4 illustrates an examples of a gNB Tx-Rx time (e.g., t4-t1). The configuration information may include one or more Rx beam indices and/or a boresight direction for an Rx beam (e.g., for each Rx beam) at a TRP. For example, the active WTRU may indicate to the network which Rx beam index to use to receive the SRSp transmitted by the active WTRU. The active WTRU may receive information about the spatial filters used by the TRP to receive an UL RS from the active WTRU. The spatial filters may be indicated, for example, by one or more DL-RS resource IDs (e.g., CSI-RS resource IDs or PRS resource IDs). The configuration information may include an expected RTT and a gNB ID, a WTRU ID, a PRS resource ID (e.g., transmitted by the gNB), and/or an SRSp resource ID (e.g., transmitted by a non-active WTRU and intended for the gNB), etc. The configuration information may include SRSp configuration information such as SRSp resources, comb values, repetition factors, a number of symbols, a transmission periodicity, and/or a symbol/slot offset. The configuration information may include a DL-RS resource set ID such as a PRS resource set ID. The configuration information may include transmission parameters for a PRS such as the periodicity of the PRS transmission, a muting pattern for the PRS, and/or a comb pattern of PRS. The configuration information may include the boresight angles of transmitted reference signals such as a PRS. The configuration information may include the expected AoD of a reference signal such as a PRS at a TRP, a range of AoD (e.g., minimum and maximum values of the AoD and/or lower and upper bounds of the AoD). The configuration information may include the expected AoA of a reference signal such as a PRS at an intended PRU/WTRU (e.g., minimum and maximum values of the AoA and/or lower and upper bounds of the AoA). The configuration information may include the location of the TRP from which a PRS may be transmitted. The configuration information may include one or more threshold values (e.g., a threshold used by the active WTRU to determine whether to include certain measurements in a report, whether to terminate obstacle positioning, and/or whether send a report to the network).

The active WTRU may be configured to transmit an UL-RS such as an SRS or an SRSp based on a condition. The active WTRU may transmit the UL-RS (e.g., which may be preconfigured for the WTRU) using UL-RS resources associated with the UL-RS and/or based on one or more of the following conditions. For example, the active WTRU may transmit the UL-RS if the RSRP of a PRS associated with a non-active WTRU is above a threshold. The active WTRU may transmit the UL-RS if the difference between the angle of arrival at the active WTRU of a PRS intended for a non-active WTRU and the expected AoA at the intended non-active WTRU is above a threshold. The angle of arrival at the active WTRU may be the measured angle of arrival of the PRS intended to be received by the non-active WTRU. The expected angle of arrival may be the angle of arrival of the PRS at the intended non-active WTRU. The difference between the actual angle of arrival reported by the active WTRU and an expected angle of arrival at the intended non-active WTRU may indicate that the PRS may have been reflected off an obstacle and have reached the active WTRU unintentionally. The active WTRU may transmit the UL-RS if the difference between the angle of arrival of a PRS and a translated angle of arrival based on the boresight direction of the PRS is above a threshold, where the translated angle of arrival may be determined based on the boresight direction of the PRS, the location of the transmission source (e.g., a TRP), and/or the location of an intended recipient (e.g., a non-active WTRU) of the PRS. The active WTRU may transmit the UL-RS if the difference between an expected RTT associated with a measured PRS, and a derived RTT (e.g., derived based on the gNB Tx-Rx time associated with the measured PRS) is greater than a threshold. Such a difference may occur if there is a mismatch between the SRSp and the PRS used by the WTRU to compute the RTT.

In examples, if one or more of the conditions described above are not satisfied (e.g., if none of the above conditions are satisfied), the active WTRU may perform one or more of the following. The active WTRU may not send a measurement report to the network at a measurement reporting occasion. The active WTRU may not send an SRSp or a report corresponding to a Rx-Tx time to the network. The active WTRU may request the network to send a PRS from a different TRP intended for a different non-active WTRU. The active WTRU may determine to send the request after none of the conditions is satisfied for a preconfigured number of occasions (e.g., consecutively). The active WTRU may enter a power saving mode (e.g., the active WTRU may not perform measurements of reference signals), and may initiate obstacle positioning based on receiving an indication from the network. For example, the active WTRU may receive a threshold value from the network, and the active WTRU may determine to enter the power saving mode after the number of occasions (e.g., consecutive occasions) at which none of the conditions is satisfied exceeds the threshold.

The active WTRU may be configured with the priorities of one or more of the conditions described above. For example, the active WTRU may receive an indication from the network (e.g., LMF, gNB, and/or the like) that the priority level of angle related conditions is higher than that of a RSRP related condition, and the active WTRU may determine to not send a measurement report (e.g., cancel the transmission of a report) if none of the angle related conditions described herein is satisfied even if the RSRP of the received PRS is above the threshold (e.g., even if a RSRP related condition is satisfied).

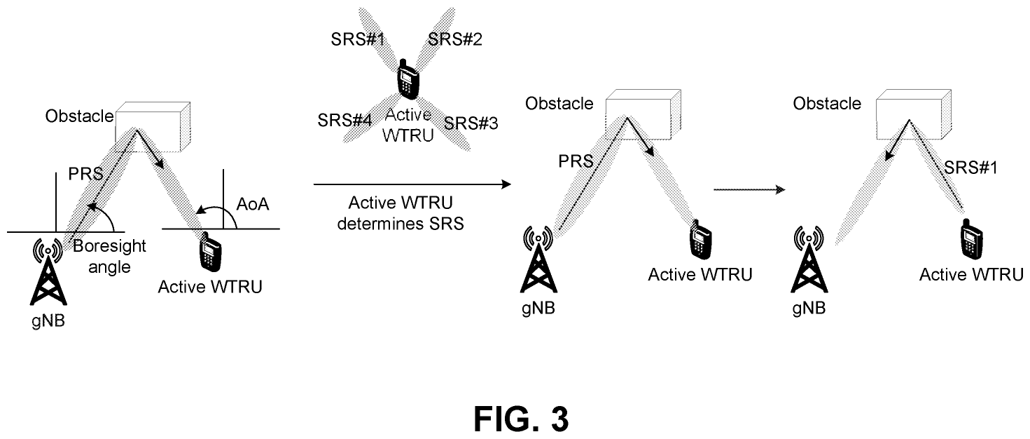

The active WTRU may report one or more of the following information to the network (e.g., LMF, gNB, and/or the like). The reported information may include a PRS resource ID. For example, the active WTRU may report the resource ID of a PRS received by the active WTRU, which may be used to compute the WTRU Tx-Rx time and/or determine an SRSp for transmission. The reported information may include the SRSp resource ID associated with an SRSp transmitted by the WTRU, for example, among multiple SRSp resources configured by the network. FIG. 3 illustrates an example of transmitting an SRSp along the direction of a PRS received by the active WTRU (e.g., the SRSp and the PRS may be considered spatially aligned in this case). In an example, the network may send an indication to the WTRU, indicating that a PRS beam and an SRSp beam are aligned. Such an indication may be expressed in terms of spatial QCL type D, by relating PRS resource IDs with SRSp resource IDs and/or indicating that the PRS sources and SRSp resources are related or spatially aligned, etc. In such a case, a gNB may expect to receive the SRSp transmitted by the active WTRU using an Rx beam that may be beamformed toward the same direction in which the PRS is transmitted. The reported information may include the TRP ID of a TRP expected to receive the SRSp transmitted by the Active WTRU. The report information may include the boresight angle of an SRSp transmission. For example, the WTRU may inform the network of the boresight angle of an SRSp transmission such that the network may prepare a spatial filter to receive the transmitted SRSp. The reported information may include an expected AoA at a TRP. For example, the active WTRU may inform the network of the expected AoA and/or range of AoA with which a TRP may expect to receive a transmitted SRSp. The active WTRU may associate an expected AoA and/or range of AoA with an SRSp resource ID. The WTRU may determine the expected AoA and/or range of AoA based on the angle of arrival of a PRS, the location of an intended recipient of the PRS, and/or the location of the TRP from which the PRS may be transmitted. The reported information may include one or more expected Rx beam indices at a TRP. For example, the active WTRU may report to the network an Rx beam index and/or a DL RS resource ID (e.g., a PRS resource ID) with which the TRP may align a spatial filter to receive an SRSp transmitted by the active WTRU.

The reported information may include a WTRU Tx-Rx time. For example, the active WTRU may report the difference between the reception time of a PRS and the transmission time of an SRSp. FIG. 4 illustrates an example of a WTRU Tx-Rx time (e.g., t3-t2). The reported information may include a WTRU ID which may be an intended recipient of the PRS whose measurements are reported by the active WTRU. The reported information may include the RSRP of a PRS received on a configured PRS resource. The active WTRU may store RSRP measurements per measurement occasion (e.g., for each PRS resource used for periodic PRS transmissions during a measurement duration), and may report the stored RSRP measurements. In examples, the active WTRU may process RSRP measurements (e.g., calculate an average the RSRP measurements) performed during a measurement duration and may send the processed RSRP measurements to the network. The reported information may include a PRS ID associated with a measured PRS. The PRS ID may be used to generate a sequence of complex numbers, which may be mapped to resource elements in one or more PRS symbols. The reported information may include a transmission source ID (e.g., TRP ID or cell ID) from which a measured PRS may be transmitted. The reported information may include the time of arrival of a PRS. The reported information may include the angle of arrival of a PRS. The reported information may include an estimated AoD at a TRP (e.g., the estimated AoD may be determined by the active WTRU based on the angle of arrival). The reported information may include an Rx beam index used to receive a PRS. The reported information may include the panel ID of a panel used to receive a PRS.

The active WTRU may receive report configuration information from the network. For example, the active WTRU may receive one or more of the following parameters: reporting periodicities (e.g., reporting occasions scheduled at configured intervals such as in terms of slots, symbols, frames, subframes, and/or time such as 5 ms or 10 ms), the starting time of a report, a maximum number of PRS resources and/or WTRU Tx-Rx measurements to report, PRS resources IDs (e.g., the active WTRU may be configured to report measurements and corresponding WTRU Rx-Tx measurements for PRS resources indicated by the network), WTRU IDs (e.g., the active WTRU may be configured to report measurements and corresponding WTRU Rx-Tx measurements for PRS(s) intended for the listed WTRU IDs), or whether to report an RSRP, an RSTD, a ToA, an AoA, an AoD, an estimated AoD, and/or a translated AoA.

The active WTRU may receive PRS configuration information from the network. The active WTRU may determine to initiate obstacle positioning, for example, if the RSRP of a configured PRS is below a threshold. The WTRU may request assistance information from the network. The active WTRU may receive assistance information from the network (e.g., LMF), where the assistance information may include one or more of the following: an expected RTT associated with a PRS resource ID, a TRP ID, and/or a WTRU ID, a gNB Tx-Rx time associated with a TRP ID, a PRS resource ID, an SRSp resource ID, and/or a WTRU ID, a time offset T, a monitoring duration, SRSp resources configured for the active WTRU, where a SRSp resource (e.g., each SRSp resource) may be associated with a respective boresight angle, PRS resources IDs for PRS monitoring, and/or the recipient(s) of a PRS, which may be represented by, e.g., a WTRU ID. The active WTRU may determine which PRS resources to monitor based on an indication from the network. For example, at T time units (e.g., seconds) after the active WTRU receives assistance information, the active WTRU may initiate obstacle positioning. The active WTRU may receive a PRS intended for a non-active WTRU, measure an AoA and/or an RSRP of the PRS resource, and determine an SRSp to transmit based on the measured AoA for the PRS and/or the boresight angle of an SRSp resource such that the difference between the measured AoA and the boresight angle may be below a threshold. If the active WTRU cannot find a suitable SRSp, the active WTRU may send a request to the network for SRSp resources. If one or more of the following conditions are satisfied, the active WTRU may send a measurement report to the network (e.g., LMF). The active WTRU may send the measurement report if the difference between an expected RTT associated with the measured PRS resource ID and a derived RTT (e.g., derived based on a gNB Tx-Rx time associated with the measured PRS resource ID) is greater than a preconfigured threshold, or if the RSRP of the measured PRS resource is above a preconfigured threshold. The measurement report may include the RSRP of the PRS, an RTT, and/or a SRSp resource ID corresponding to the SRSp. If the RSRP of the measured PRS resource is below or equal to the threshold, the WTRU may not send the measurement report. The active WTRU may continue to monitor the configured PRS resources after determining which PRS resources to monitor based on an indication from the network (e.g., as described herein). After the monitoring duration ends, the active WTRU may terminate the obstacle positioning.

The activate WTRU may be configured to estimate the position of an obstacle. In examples, the active WTRU may be configured to monitor, receive, and/or measure SRSp(s) transmitted from non-active WTRU(s). Based on the measurements, the active WTRU may determine the position of the obstacle. The active WTRU may also report the measurements to the network (e.g., LMF, gNB, and/or the like).

The active WTRU may receive one or more of the following configuration information from the network (e.g., gNB, LMF, and/or the like), e.g., after the active WTRU receives an indication to perform an UL-based estimation of an obstacle. The configuration information may include, for example, information related to UL-RS resource(s) configured for the active WTRU such as a number of SRSp symbols, a repetition factor, a frequency allocation, a bandwidth, a comb factor associated with an SRSp, an SRSp resource ID, an SRSp ID, a boresight angle of transmission, etc. The configuration information may include information related to UL-RS resource(s) configured for an non-active WTRU such as a number of SRSp symbols, a repetition factor, a frequency allocation, a bandwidth, a comb factor associated with an SRSp, an SRSp resource ID, an SRSp ID, a boresight angle of transmission, etc. The configuration information may include an intended recipient of an UL-RS transmitted by a non-active WTRU (e.g., indicated by a TRP ID and/or a cell ID). The configuration information may include an expected angle of arrival of an UL-RS transmitted by a non-active WTRU at an intended recipient (e.g., a TRP). The configuration information may include a non-active WTRU ID, the location of a non-active WTRU that may transmit an SRSp, and/or a threshold value (e.g., which may be used by the active WTRU to determine whether to include certain measurements in a report, whether to terminate obstacle positioning, and/or whether send a report to the network). The configuration information may include an LOS/NLOS indicator associated with an SRSp resource or a WTRU ID.

The assistance information described herein such as boresight information may be provided (e.g., configured) for the active WTRU, for example, if WTRU-based obstacle positioning is used. The active WTRU and a non-active WTRU may receive the configuration information described herein via broadcast messages (e.g., in an SIB and/or a posSIB) or WTRU-dedicated message (e.g., an RRC message, an LPP message, DCI, and/or an MAC-CE). The active WTRU may determine to monitor an SRSp based on the resource configuration described herein.

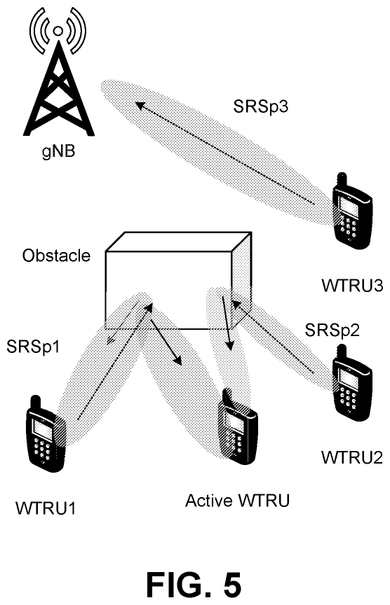

FIG. 5 shows an example of obstacle positioning based on an UL-AoA. An UL-based obstacle location estimation as shown in FIG. 5 may include the active WTRU monitoring SRSps (e.g., SRSp1, SRSp2, and SRSp3) transmitted by multiple WTRUs (e.g., WTRU1, WTRU2, and WTRU3), respectively. The active WTRU may make measurements on SRSp1 and SRSp2, which may be reflected off an obstacle. The active WTRU may not make measurements on SRSp3, which may reach the intended recipient, e.g., a gNB.

The active WTRU may be configured with a monitoring window during which the active WTRU may monitor an SRSp transmitted by a non-active WTRU. In response to receiving the SRSp, the WTRU may determine the position of an obstacle based on one or more measurements. In examples, the active WTRU may be provided with a TDD configuration for monitoring SRSp(s) transmitted from other WTRUs (e.g., non-active WTRUs). The TDD configuration may include downlink slots for monitoring the SRSp(s). Uplink slots in the TDD configuration may be used to transmit a measurement report to the network (e.g., gNB or LMF).

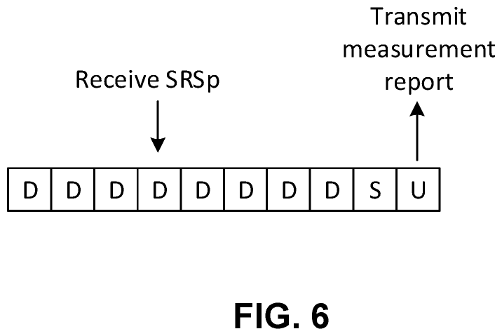

FIG. 6 shows an example of a TDD configuration for the active WTRU. As shown in FIG. 6, “D”, “S” and “U” may denote downlink slots, special slots, and uplink slots, respectively. A special slot may include one or more downlink, flexible, or uplink symbols. In examples, the WTRU may receive an SRSp from a non-active WTRU in downlink slot #4 and may transmit a measurement report including measurements the WTRU performed on the received SRSp in an uplink slot. During the downlink slots, the WTRU may be configured with a measurement gap by the network (e.g., gNB or LMF), for example, so that the WTRU may not receive reference signals or downlink channels from the network during the measurement gap.

The active WTRU may monitor for an SRSp based on a semi-static configuration. For example, the WTRU may receive RRC configuration information indicating a periodicity and/or a monitoring pattern for an SRSp in a time window. The WTRU may receive a duration and/or start and end times (e.g., expressed in terms of number of symbols, slots, frames, or subframes) of the time window.

A non-active WTRU may be configured to transmit an SRSp. The non-active WTRU may be provided with a TDD configuration, where the configuration may include a combination of uplink slots and downlink slots. The non-active WTRU may transmit an SRSp in one or more uplink slots and may receive a command for a next transmission in one or more downlink slots. The non-active WTRU may be configured with multiple sets of SRSps, where the sets (e.g., each set) may be associated with a different beamwidth or frequency range (e.g., FR1, FR2, FR2-1, and/or FR2-2).

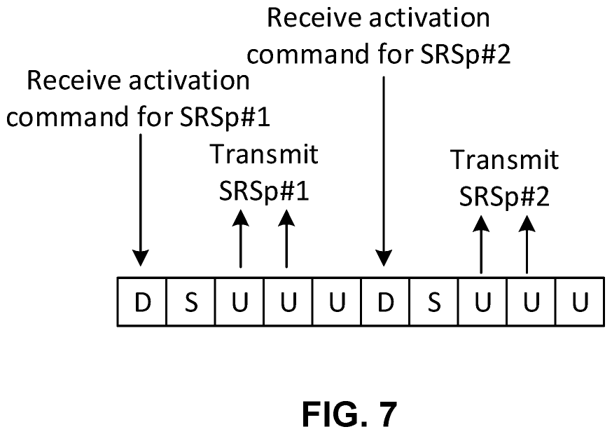

FIG. 7 shows an example of a TDD configuration for a non-active WTRU. The non-active WTRU may receive an activation command from the network for SRSp resource #1 in a first downlink slot. Based on the command, the non-active WTRU may transmit SRS #1 in one or more uplink slots (e.g., third and fourth slot as shown in FIG. 7). The non-active WTRU may receive an activation command for SRSp resource #2 and a deactivation command for SRSp #1 in the second downlink slot. Based on the command, the non-active WTRU may transmit SRSp #2 in one or more uplink slots (e.g., eighth and ninth slot as shown in FIG. 7). The WTRU may transmit an SRSp based on a semi-static configuration. For example, the non-active WTRU may receive an RRC configuration indicating a periodicity and/or a transmission pattern of an SRSp in a time window. The non-active WTRU may receive the duration and/or start and end times (e.g., expressed in terms of number of symbols, slots, frames, or subframes) of the time window.

In examples, the non-active WTRU may be configured to monitor beam sweeping performed by the active WTRU. For example, the beam sweeping pattern may include a repetition factor for an SRSp resource (e.g., each SRSp resource), the number of SRSp resources, SRSp resource indices, SRSp resource set indices, and/or the duration of beam sweeping. The non-active WTRU may receive the beam sweeping configuration via a broadcast message (e.g., in an SIB and/or posSIB) or a dedicated message (e.g., an LPP message, an RRC message, DCI, and/or a MAC-CE).

WTRU-assisted obstacle positioning may be activated based on certain conditions. An active WTRU may be configured to report measurements related to an SRSp that the active WTRU measures. The active WTRU may send a measurement report to the network (e.g., LMF, gNB, and/or the like) if one or more of the following conditions related to measurements made on a monitored SRSp resources is satisfied: the RSRP of the SRSp (e.g., which may be associated with a non-active WTRU) is above a threshold; if the difference between an expected angle of arrival of the SRSp at an intended TRP and a measured AoA at the active WTRU is above a threshold; if the difference between a translated angle of arrival of the SRSp and a measured AoA at the active WTRU is above a threshold. The translated angle or arrival may be computed based on the location of the non-active WTRU, the location of the intended TRP, and/or the boresight angle of the SRSp transmission.

In examples, if one or more of the above conditions are not satisfied (e.g., if none of the above conditions are satisfied), the active WTRU may perform one or more of the following. The active WTRU may not send a measurement report to the network at a measurement reporting occasion. The active WTRU may request the network to send an SRSp from a different non-active WTRU and/or intended for a different TRP. The active WTRU may determine to send the request based on the one or more conditions not being satisfied for a preconfigured number of occasions (e.g., consecutively). The active WTRU may enter a power saving mode (e.g., the active WTRU may not perform measurements of reference signals), and may initiate obstacle positioning in response to receiving an indication from the network. For example, the active WTRU may receive a threshold from the network, and the active WTRU may determine to enter the power saving mode based on the number of occasions (e.g., consecutive occasions) at which the one or more conditions are not satisfied exceeding the threshold.

The active WTRU may be configured with priorities for the conditions. In examples, the active WTRU may determine to not send a measurement report (e.g., cancel transmission of the report) if none of the angle related conditions described herein is satisfied even if the RSRP of the received PRS is above the threshold (e.g., if the angle related conditions are given higher priorities than the RSRP related condition).

The active WTRU may include one or more of the following measurements in the report: the RSRP of the received SRSp; the AoA of the received SRSp; the translated angle of arrival of the received SRSp; the SRSp resource ID for the received SRSp; the SRSp resource set ID associated with the received SRSp; the beam index used to receive the SRSp; the panel ID of the panel used to receive the SRSp; or an ID or index number associated with the SRSp. In examples, the WTRU may associate the parameters described herein with a measurement (e.g., if the active WTRU receives multiple SRSps on the configured SRSp resources).

In examples, a WTRU (e.g., the active WTRU described herein) may receive PRS configuration information from the network. The active WTRU may determine to initiate obstacle positioning, for example, if the RSRP of a configured PRS is below a threshold. The WTRU may request assistance information from the network. The active WTRU may receive assistance information from the network (e.g., LMF), where the assistance information may include one or more SRSp resource IDs, SRSp details (e.g., periodicity) configured for non-active WTRUs, and/or expected AoA angles at an intended TRP associated with each SRSp. The active WTRU may receive an SRSp and may measure its RSRP and/or AoA. If the difference between an expected AoA and the measured AoA is larger than a threshold, the WTRU may send a measurement report to the network (e.g., LMF), where the measurement report may include an SRSp resource ID for the received SRSp, an AoA of the received SRSp, and/or an RSRP. The active WTRU may continue to monitor configured SRSp resources transmitted from non-active WTRUs. The active WTRU may initiate obstacle positioning if the RSRP of another configured PRS is below a threshold. Based on the initiation of the obstacle positioning, the WTRU may request assistance information from the network and repeat the operations described above. In examples, if the active WTRU receives an explicit termination indication from the network (e.g., LMF), the active WTRU may terminate the obstacle positioning.

As described herein, WTRU-assisted obstacle positioning may be performed by configuring a WTRU to transmit reference signals, make measurements associated with the reference signals, and/or report the measurements to the network so that the network or WTRU may detect the presence of an obstacle.

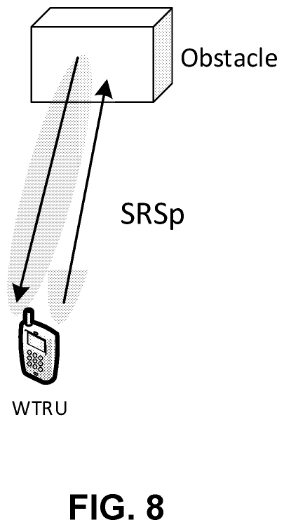

FIG. 8 shows an example of a WTRU transmitting an SRSp towards an obstacle and making measurement(s) related to the transmitted SRSp (e.g., the WTRU may measure the SRSp reflected from the obstacle). The WTRU may report the measurement(s) to the network (e.g., LMF or gNB). The WTRU may receive SRSp configuration information from the network for the WTRU to transmit one or more SRSps on different resources (e.g., beams). The SRSp configuration information may indicate a transmission periodicity associated with the SRSps, a repetition factor associated with the SRSps, spatial information associated with the SRSps, etc.

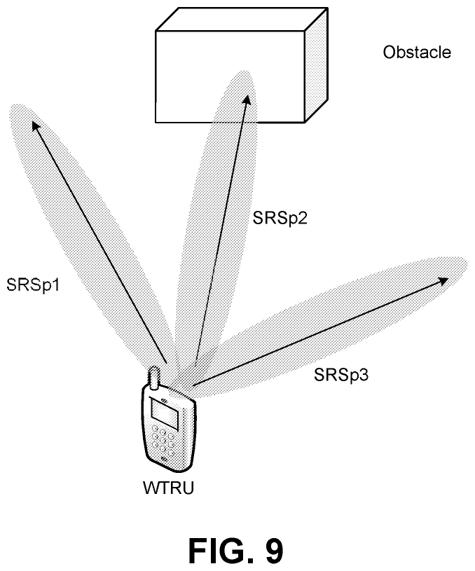

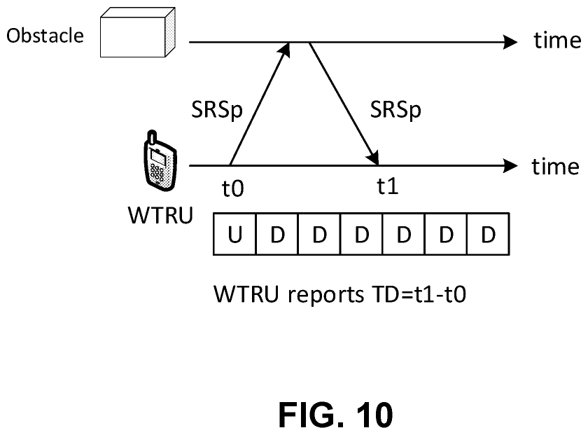

FIG. 9 shows an example of a WTRU transmitting SRSps in different directions, e.g., using respective SRSp resources. FIG. 10 shows examples of a timeline for SRSp transmission and reception, and a Time Division Duplex (TDD) configuration. As shown in FIG. 10, a WTRU may be configured with a TDD configuration such that the WTRU may transmit an SRSp during one or more uplink slots and receive a reflected SRSp in one or more downlink slots. The WTRU may be configured to measure the SRSp that the WTRU transmits and/or the reflected SRSp.

The WTRU may be configured (e.g., by the network) to include one or more of the following measurements in a measurement report: an SRSp resource ID; an SRSp resource set ID; the time difference between a transmission time and a reception time of an SRSp (e.g., the time difference may be t1-t0 shown in FIG. 10); an RSRP corresponding to a received SRSp associated with an SRSp resource ID and/or an SRSp resource set ID; a (e.g., per-path) RSRP of an SRSp (e.g., if the WTRU receives multiple copies of the SRSp); a relative (e.g., per-path) RSRP of an SRSp (e.g., if the WTRU receives multiple copies of the SRSp), where the relative (e.g., per-path) RSRP may be computed with respect to the highest RSRP; a relative time delay of an SRSp (e.g., if the WTRU receives multiple copies of the SRSp), where the relative time delay may be computed with respect to the time of arrival of the first SRSp; an Rx beam index used to receive an SRSp; an indication on whether the WTRU has rotated or not; an angle of arrival of a received SRSp; or whether the same Rx beam has been used compared to previous measurement reporting and/or measurement occasions.

Measurements corresponding to an SRSp (e.g., an SRSp measurement such as an RSRP included in a measurement report) may be identified by and/or associated with the SRSp resource ID or resource index for the SRSp. The measurements described above may depend on the obstacle positioning technique that the WTRU is configured with (e.g., timing-based positioning, angle and/or power-based positioning, etc.). The WTRU may send the measurement report to the network (e.g., LMF, gNB).

The WTRU may receive one or more of the following assistance information from the network (e.g., with respect to obstacle positioning): an expected time difference (e.g., t1-t0 shown in FIG. 10) associated with an SRSp resource; an expected angle of arrival associated with an SRSp resource ID; a measurement gap configuration; a TDD configuration, where the network may indicate uplink and downlink slot configurations (e.g., as shown in FIG. 10, where “U” may indicate an uplink slot and “D” may indicate a downlink slot); a full-duplex configuration and/or indication, during which the WTRU may turn on or off Tx and/or Rx antennas (e.g., freely) to receive or transmit; configuration information related to a time window during which the WTRU may be expected to transmit an SRSp and/or make measurements on the transmitted SRSp. The configuration information related to the time window may indicate a window duration, a periodicity, and/or start and end times of the window (e.g., expressed in terms of symbols, slots, and/or frames). During the configured time window, the WTRU may transmit an SRSp and make measurements related to the transmitted SRSp. Once the WTRU reaches the end of the time window, the WTRU may cease SRSp transmissions and send one or more of the measurements performed to the network.

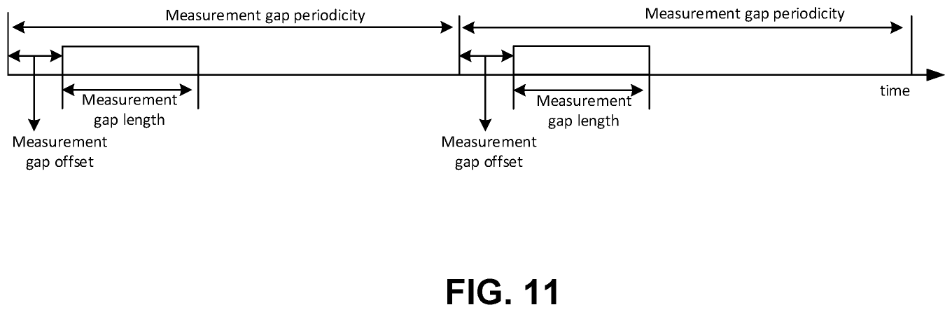

FIG. 11 shows an example of a measurement gap. The duration of the measurement gap may be indicated by the measurement gap length shown in FIG. 11, during which the WTRU may make measurements, and may not be expected to transmit and/or receive data. Outside of the measurement gap, the WTRU may be expected to transmit and/or receive data. The measurement gap may be configured with a measurement gap offset and/or a measurement gap periodicity.

The WTRU may be provided with configuration information associated with sensing. The WTRU may be configured by the network (e.g., gNB or LMF) to perform sensing (e.g., transmit an SRSp, receive an SRSp including a reflected SRSp, make measurements, etc.). The WTRU may receive SRSp configuration information from the network. The WTRU may be configured to perform sensing during an RRC_CONNECTED or an RRC_INACTIVE mode. The WTRU may be configured to perform sensing during initial access. For example, the WTRU may transmit physical random access channel (PRACH) preambles at random access channel (RACH) occasions, which may be associated with the sensing capabilities of the WTRU. The WTRU may indicate its sensing capabilities, e.g., by transmitting PRACH preambles at one or more RACH occasions. In a RACH related message (e.g., such as a RACH response or msg2), the WTRU may receive configuration information related to an SRSp that the WTRU may use for sensing. The WTRU may perform sensing after the WTRU receives the SRSp configuration information from the network. In examples, the WTRU may receive the SRSp configuration information (e.g., for sensing) from the network in broadcast message(s) (e.g., in a system information block (SIB) and/or a positioning SIB) or in WTRU-dedicated message(s).

In examples, the WTRU may be configured, by the network, with a timing offset associated with sensing (e.g., for transmitting an SRSp, receiving an SRSp, and/or making measurements on an SRSp including a reflected SRSp). For example, the WTRU may receive an indication from the network to perform sensing at a time offset of T seconds (e.g., after the WTRU receives the indication), and the WTRU may, at T seconds from the moment the WTRU receives the indication, initiate sensing. The time offset, T, may be expressed in terms of seconds, number of symbols, slots, frames, etc. The WTRU may receive an absolute time from the network at which the WTRU may perform sensing. The start time may be associated with other configurations that the WTRU may receive from the network (e.g., activation of a dynamic grant or configured grant). For example, the WTRU may receive an indication to start sensing at the next occasion at which a dynamic or configured grant is activated. The WTRU may receive an indication to start sensing at a next uplink slot in a configured or dynamic grant.

The WTRU may receive configuration information regarding SRSps of different beamwidths (e.g., wide beams and narrow beams) and/or a relationship between these SRSps (e.g., a group of wide beam SRSps may be associated with a group of narrow beam SRSps). The WTRU may receive the configuration information in broadcast message(s) or WTRU-dedicated message(s) from the network. The WTRU may receive an ID from the network (e.g., WTRU-specific ID, temporary ID, etc.) with which the WTRU may scramble an SRSp sequence (e.g., to minimize the interference that the SRSp transmission may cause to other WTRUs).

The WTRU may determine to perform sensing if the WTRU's location is known by the network or the WTRU. The WTRU may determine its location by performing WTRU-based positioning. The WTRU may receive an indication and/or SRSp configuration information from the network to perform sensing, e.g., if the WTRU's location is known by the network. The indication for sensing may be implicit. For example, the WTRU may be configured with spatial information or QCL information related to an SRSp resource, where a target SRSp resource and a reference SRSp resource may be the same. In such a case, the WTRU may determine to use the SRSp for sensing (e.g., the WTRU may transmit the SRSp and/or make measurements on the SRSp). As another example, if two resources are related by QCL (e.g., by QCL type D or QCL type B), it may indicate that the two resources may share similar channel characteristics such as similar spatial characteristics (e.g., similar RSRP attenuation for QCL type D or similar Doppler spread and/or Doppler shift for QCL type B).

In examples, the WTRU may be configured with more than one group of SRSp resources, where the groups may correspond to different beamwidths (e.g., wide beams or narrow beams), different frequency ranges (e.g., FR1, FR2, FR2-1, FR2-2, kHz, GHz, and/or THz), different relative angles with respect to a reference angle or point, and/or different absolute angles. A group (e.g., each group) of SRSp resources may include more than one SRSp resource, and a group of beams may include more than one beam.

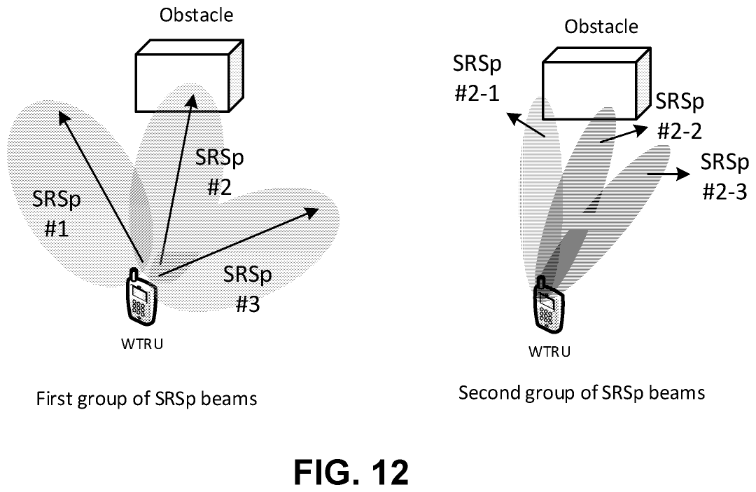

FIG. 12 shows examples of SRSp resource or beam groups, where SRSp2-1, SRSp2-2 and SRSp2-3 (e.g., associated with narrow beams) in a second group (or set) may be spatially aligned with SRSp2 (e.g., associated with a wide beam) in a first group (or set).

The WTRU may be configured to perform beam sweeping using SRSp resources in a (e.g., one) configured group of SRSp resources (e.g., a first group of SRSp resources or beams). Such a first group may, for example, correspond to the group of beams with the widest beamwidths. The WTRU may determine an SRSp from the first group that has the largest RSRP, which may be referred to as the primary SRSp. Based on measurements (e.g., RSRP measurements) of the first group of SRSp resources, the WTRU may determine to transmit a second group of SRSp beams that may spatially aligned with the primary SRSp (e.g., as shown in FIG. 12, where SRSp #2-1, SRSp #2-2 and SRSp #2-3 in the second group may be spatially aligned with SRSp #2 in the first group). In the examples provided herein, an SRSp resource (e.g., beam) in the second group may be considered to be spatially aligned or spatially related to an SRSp resource (e.g., beam) in the first group if a transmission spatial filter associated with the former resource is within a preconfigured angle and/or range of angles of a transmission spatial filter associated with the latter resource. The WTRU may receive an indication from the network that one or more SRSp resources in the second group are spatially related to a SRSP resource in the first group. The beams in the second group may have narrower beamwidths than the beams in the first group of SRSp beams. The WTRU may determine to choose a sub-group (e.g., subset) of SRSp resources from the second group based on the number of resources, N, that the WTRU may configured (e.g. by the network) to choose.

The WTRU may determine the number of beams in the second group based on one or more of the following: the SRSp resource ID with the largest RSRP in the first group (or set); the SRSP resource ID with the shortest time difference between the transmission time and reception time of the SRSp; spatial relation information of the SRSp resources; etc. With respect to the spatial information, a target and a source signal (e.g., reference signal) may be indicated, where the target and source signals may be aligned spatially. The target and source signals may be DL signals (e.g., DL RS) and/or UL signals (e.g., UL RS). For example, if the spatial relation information of SRSp #2 and SRSp #2-1 in FIG. 12 indicates SSB #2 as the source signal, the WTRU may determine that SRSp #2 and SRSp #2-1 may be spatially related. If the beamwidth of SRSp #2 is larger than the beamwidth of SRSp #2-1, the WTRU may determine that SRSP2-1 may be spatially contained in SRSp #2.

In examples, the WTRU may be configured to transmit an SRSp, make measurements on the transmitted SRSp (e.g., including a signal reflected from the SRSp), and/or receive a parameter N that may indicate the number of SRSp resources in a group of SRS resources associated with narrow beams. The WTRU may receive configuration information regarding multiple groups (e.g., two groups) of SRSps (e.g., beamwidth and/or spatial information for the groups), where a first group may include beams with wider beamwidths than the beams in a second group. The WTRU may be configured with a TDD configuration (e.g., uplink and downlink slot configuration). The WTRU may transmit an SRSp in the first group of SRSps in one or more uplink slots and may measure a corresponding RSRP in one or more downlink slots. The WTRU may determine the SRSp resource with the largest RSRP (e.g., a primary SRSp). The WTRU may determine N (e.g., N>=1) SRSp resources from the second group of SRSp resources, where the N SRSps may be spatially aligned with the primary SRSp (e.g., determined based on configured spatial information). The WTRU may transmit the N SRSps, make measurements on the N SRSps (e.g., including reflection of the N SRSps), and report the measurement (e.g., RSRP measurements) to the network. In examples, the WTRU may report the RSRP of the SRSp from the first group and request that the network configure the second group of SRSp resources. The WTRU may receive the second group of SRSp resources, which may be spatially aligned with at least the SRSp with the largest RSRP from the first group.

The WTRU may determine the SRSp beam from the first group of SRSp resources with the shortest time difference between times of transmission and reception (e.g., of a reflected SRSp), as the primary SRSp (e.g., the primary SRSp may be determined based on RSRP measurement, time differences, etc.). The time difference between the transmission time of an SRSp and the reception time of the SRSp may be as illustrated by FIG. 10. The WTRU may determine a sub-group of SRSp(s) from the second group of SRSp resources based on spatial alignment between those SRSp(s) and the primary SRSp.

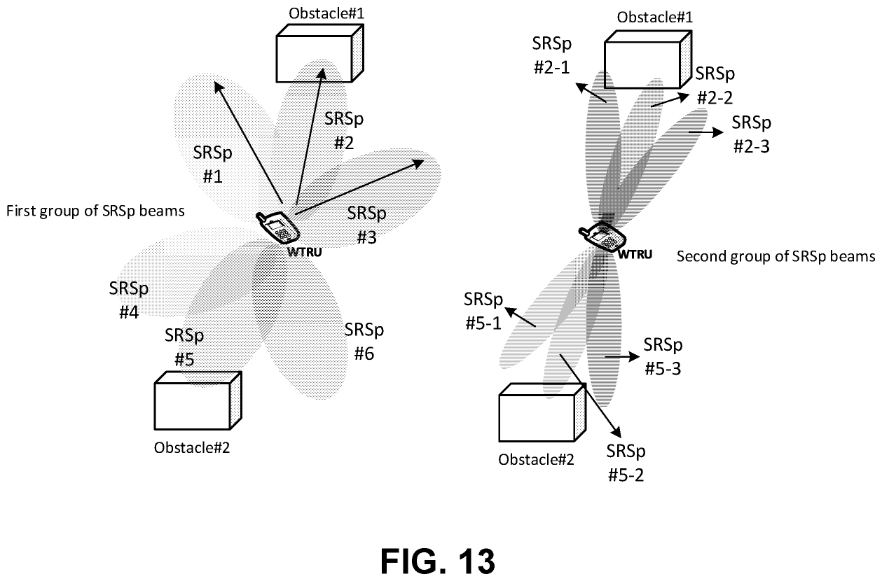

The WTRU may perform beam sweeping to detect multiple obstacles. For example, the WTRU may determine that there may be multiple obstacles in the vicinity of the WTRU, and may associate the obstacles (e.g., each obstacle) with a primary SRSp, where the primary SRSp may correspond to the SRSp with the largest or shortest time difference between a transmission time and a reception time (e.g., of a reflected SRSp). FIG. 13 illustrates an example in which the primary SRSp for Obstacle #1 may be SRSp #2 and for Obstacle #2 may be SRSp #5 (e.g., from a first group of SRSp beams shown on the left). In such a case, the WTRU may determine to send beams with narrower beams, which may be one or more of SRSp #2-1, SRSp #2-2, or SRSp #2-3 for Obstacle #1, and SRSp #5-1, SRSp #5-2, or SRSp #5-3 for Obstacle #2.

In examples where the WTRU may perform Rx beam sweeping, the WTRU may fix the transmission beam, transmit an SRSp at a configured periodicity, and change the Rx beam at the configured periodicity to receive the SRSp from a different direction. In examples, the WTRU may perform a configured beam sweeping following a sequence of SRSp transmissions. For example, the WTRU may be configured by the network to perform transmission using more than one SRSp resource with configured number of repetitions, and may sweep the resources. For example, the WTRU may be configured with 3 SRSp resources with 2 repetitions each, and the WTRU may transmit SRSp resource #1 over 2 uplink slots. In such a case, the WTRU may transmit SRSp resource #2 over 2 uplink slots and/or transmit SRSp resource #3 over 2 uplink slots. The WTRU may be configured with a beam sweeping pattern by the network. For example, the beam sweeping pattern may include a repetition factor for a SRSp resource (e.g., each SRSp resource), the number of SRSp resources, SRSp resource indices, SRSp resource set indices, and/or the duration of beam sweeping.

The WTRU may be configured to send a measurement report related to SRSp measurement and/or beam sweeping. In the measurement report, the WTRU may report an RSRP and/or a time difference between the transmission time and arrival time associated with a primary SRSp resource (e.g., indicated by an SRSp resource ID). The measurement report may include an RSRP and/or a time difference between the transmission time and arrival time associated with a second group of SRSp resources (e.g., which may be spatially aligned with the primary SRSp). The WTRU may be configured to report an RSRP and/or a time difference between the transmission time and arrival time associated with an SRSp resource (e.g., a specific SRSp resource).

If the WTRU detects multiple paths in the measurements of a received SRSp, the WTRU may include multi-path measurements in a measurement report, which may include one or more of the following measurements: a relative RSRP for a path (e.g., for each path) with respect to the path with the highest RSRP or the RSRP of a first path; or a relative time delay for a path (e.g., for each path) with respect to the time of arrival of the first path. The WTRU may be configured with a maximum number of paths that the WTRU may report to the network.

In examples, the WTRU may be configured to determine the relative position of an obstacle with respect to the WTRU. The WTRU may report angle and/or distance information of the obstacle (e.g., from the WTRU) to the network. The WTRU may determine the relative position of the obstacle based on the measurements made from one or more received SRSps.

The WTRU may determine that an obstacle is present if one or more of the following conditions is satisfied: the RSRP of a received SRSp is above a preconfigured threshold; the time difference associated with the received SRSp is less than or equal to a preconfigured threshold; the time difference associated with the received SRSp is greater than a preconfigured threshold; the time difference associated with the received SRSp is greater than a preconfigured threshold and less than or equal a preconfigured threshold; an Rx beam used to receive SRSp is spatially aligned with a transmission beam of the SRSp.

If the WTRU determines that an obstacle is present, the WTRU may determine a primary SRSp beam and may transmit a second group of SRSp beams that may be spatially aligned with the primary SRSp beam. The WTRU may send an indication to the network (e.g., in a report) that the obstacle is present, for example, by setting a target resource and a reference resource (e.g., in spatial relation information or QCL relationship) to the same SRSp resource.

In examples, the WTRU may be configured to transmit an SRSp, make measurements on the transmitted SRSp (e.g., including a reflection of the transmitted SRSp), and receive a parameter N that may indicate the number of SRSp resources in a group of SRSp resources associated with narrow beams. The WTRU may receive configuration information regarding multiple groups (e.g., two groups) of SRSps (e.g., beamwidths and/or spatial information), where a first group may include beams with wider beamwidths than the beams in a second group. The WTRU may transmit one or more SRSps in the first group of SRSp, and may measure the time difference between the transmission time and reception time of an SRSp (e.g., the reception time of a reflected SRSp). If the time difference is less or equal to a threshold, the WTRU may determine that the SRSp is a primary SRSp (e.g., SRSp resource associated with the shortest time difference). The WTRU may determine N SRSp resources from the second group or set of SRSp resources, where the N SRSp resources may be spatially aligned with the primary SRSp (e.g., determined based on configured spatial information). The WTRU may transmit SRSps using the N SRSp resources, make measurements associated with the N SRSp resources, and report the results of the measurements (e.g., time difference measurements) to the network.

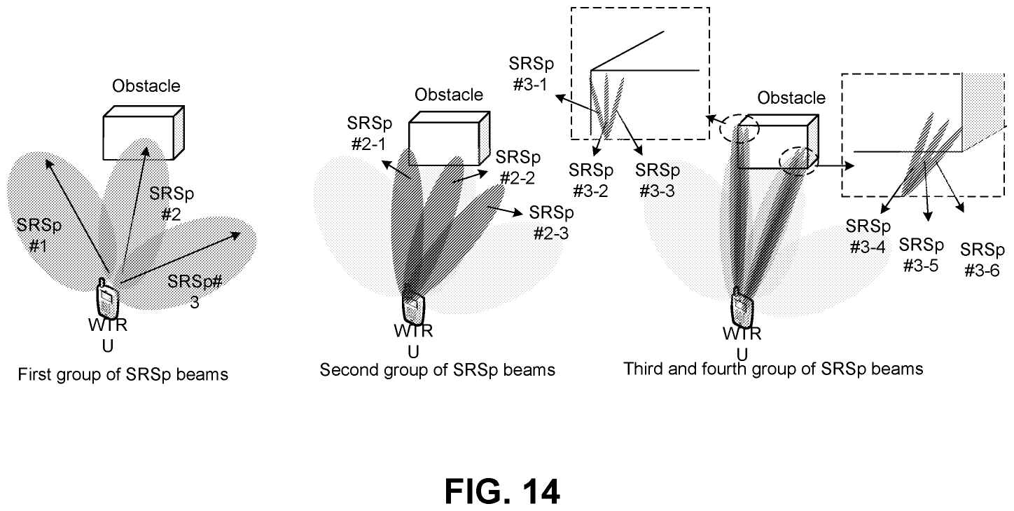

FIG. 13 shows an example of obstacle positioning for more than one obstacle, and FIG. 14 shows an example of obstacle positioning with more than one group of beams.

A relationship between frequency ranges and/or groups of beams may be provided. In examples, the WTRU may be configured with more than one group of beams. The groups of beams may be associated with different frequency ranges (e.g., FR1, FR2, FR2-1, FR2-3, and FR3) and/or relative/absolute angles, e.g., as shown in FIG. 14, where the third and fourth group of beams may be used to detect different areas of the surface of an object. Different primary SRSp resources/beams may correspond to different obstacles or different parts of the obstacle. The WTRU may indicate to the network that one or more primary SRSp resources may be associated with the same obstacle or different obstacles, e.g., by associating the primary SRSp resource ID(s) with ID(s) of the obstacle(s).

There may be a hierarchical relationship between beams. The WTRU may report to the network (e.g., LMF or gNB) a spatial relationship between measured SRSp resources. For example, as shown in FIG. 14, SRSp resource #2 may be reflected from the obstacle and the WTRU may measure a higher RSRP associated with SRSs resource #2 compared to SRSp resource #1 or SRSp resource #3. The WTRU may also measure a higher RSRP for SRSp #2-1 and SRSp #2-2 compared to SRSp #2-3, and a higher RSRP for SRSp #3-2 compared to SRSp #3-1 and SRSp #3-3. In such a case, the WTRU may report to the network a relationship or association among the SRSp resources. As shown in FIG. 14, the WTRU may associate SRSp #2-1 and SRSp #2-2 with SRSp resource #2, associate SRSp #3-2 with SRSp #2-1, and associate SRSp #3-5 with SRSp #2-3 in the report. The WTRU may provide the relationships or associations in the same report or different reports, e.g., depending on when the WTRU transmits the SRSps.

There may be hierarchies associated with obstacles. For example, if the WTRU detects more than one obstacle, the WTRU may create hierarchies for the detected obstacles, where there may be multiple levels in a hierarchy that may correspond to different levels of details (e.g., with respect to shapes, sizes, dimensions, and/or materials) of the same obstacle.

The WTRU may determine the primary SRSp described herein based on one or more of the following conditions: an RSRP of a received SRSp is above a preconfigured threshold; a time difference associated with a received SRSp is less than or equal to a preconfigured threshold; a time difference associated with a received SRSp is greater than a preconfigured threshold; a time difference associated with a received SRSp is greater than a preconfigured threshold and less than or equal a preconfigured threshold; or an Rx beam used to receive SRSp is spatially aligned with transmission beam of the SRSp.

Termination conditions and fallback behaviors associated with obstacle positioning may be provided. The WTRU may be configured with sensing parameters (e.g., a number of iterations that the WTRU may perform sensing). For example, the WTRU may repeat a beam sweeping procedure until the WTRU finds N primary SRSp resources. The WTRU may be configured with a timer and may terminate the beam sweeping procedure if the timer expires. If the WTRU cannot find a primary SRSp resource (e.g., any primary SRSp resources), the WTRU may send a request to the network so that the WTRU may be configured with other SRSp resources for positioning. The WTRU may be configured with a timer and may continue to transmit configured SRSps, for example, until the timer expires. The WTRU may terminate sensing, for example, after the WTRU transmits a number of configured SRSp(s) (e.g., all of the configured SRSps).

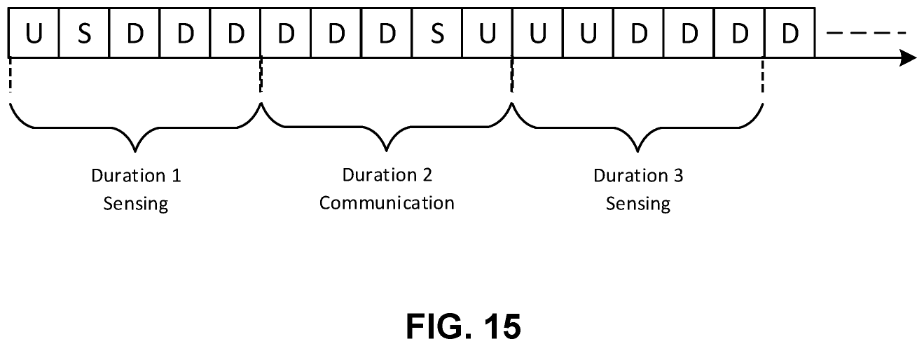

FIG. 15 shows an example of a TDD configuration that may include both sensing and communication durations. As shown in FIG. 15, the TDD configuration include three durations, where Durations 1 and 3 may be configured for sensing, and duration 2 may be configured for communication. During the duration for communication, the WTRU may receive an indication of PDSCH/PDCCH from the network and may transmit reference signals, PUCCH transmissions, or PUSCH transmissions in one or more uplink slots. In the figure, “U” may indicate an uplink slot, “D” may indicate a downlink slot, and “S” may indicate a slot that may include both downlink and uplink symbols. One or more of the slots may also include guard symbols or flexible symbols. The WTRU may receive the TDD configuration via an RRC or LPP message.

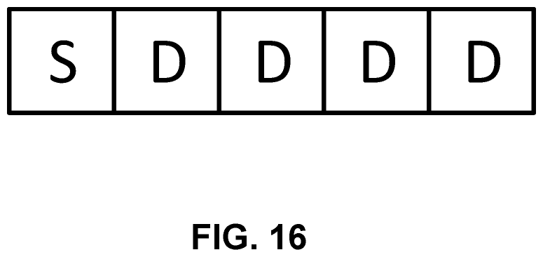

FIG. 16 shows an example of a TDD configuration that may use a fraction of a slot for uplink transmission or reception. As shown in FIG. 16, the WTRU may be configured with a special slot “S,” where the first N symbols in the slot may be dedicated for uplink transmission and the rest of the slot (e.g., 14-N symbols) may be dedicated for reception of a downlink signal (e.g., including a reflected SRSp).

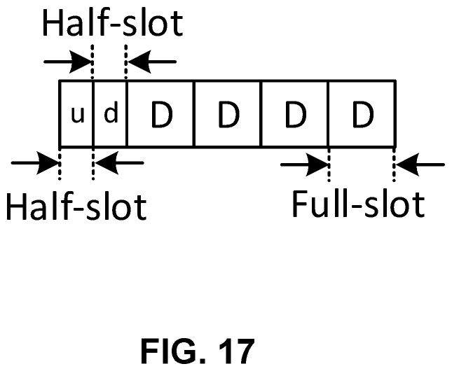

FIG. 17 shows an example of a TDD configuration that may use a mixture of half-slots and full-slots for transmission or reception. In examples, a half-slot may include half of the number of OFDM symbols of a full-slot. The WTRU may be configured to transmit an SRSp during a first half-slot, which may be configured for uplink transmission. TDD and frequency division duplex (FDD) may be used interchangeably herein.

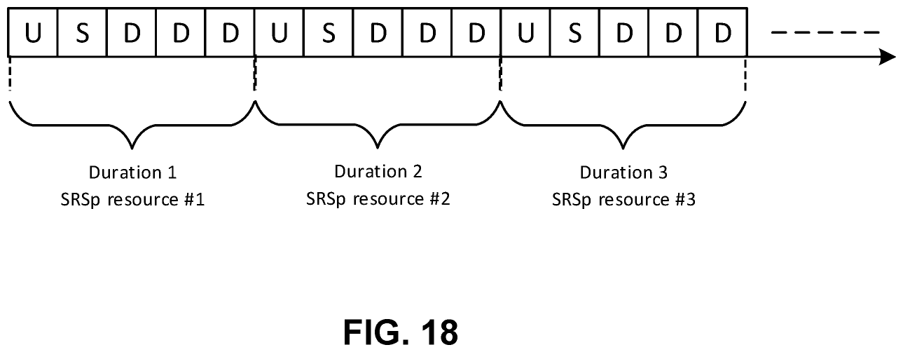

FIG. 18 shows examples of durations in a TDD configuration that may be associated with SRSp resources. A duration (e.g., each duration) in the TDD configuration may be associated with one or more SRSp resources such that the duration (e.g., each duration) may be used to sense a configured SRSp resource. For example, Duration 1 shown in FIG. 18 may be used for a transmission using SRSp resource #1 in an uplink slot (e.g., denoted “U”) and the WTRU may prepare to receive a transmission (e.g., a reflected SRSp) associated with SRSp resource #1 in one or more downlink symbols and/or slots (e.g., denoted “D”). Duration 2 may be used for a transmission using SRSp resource #2 in an uplink slot and the WTRU may prepare to receive a transmission associated with SRSp resource #2 in one or more downlink symbols and/or slots. More than one duration may be used for an SRSp resource. For example, duration 1 and duration 2 shown in FIG. 18 may both be used to perform a transmission using SRSp resource #1 in one or more uplink slots/symbols of the respective durations and to receive a transmission associated with SRSp resource #1 in one or more downlink slots/symbols of the respective durations.

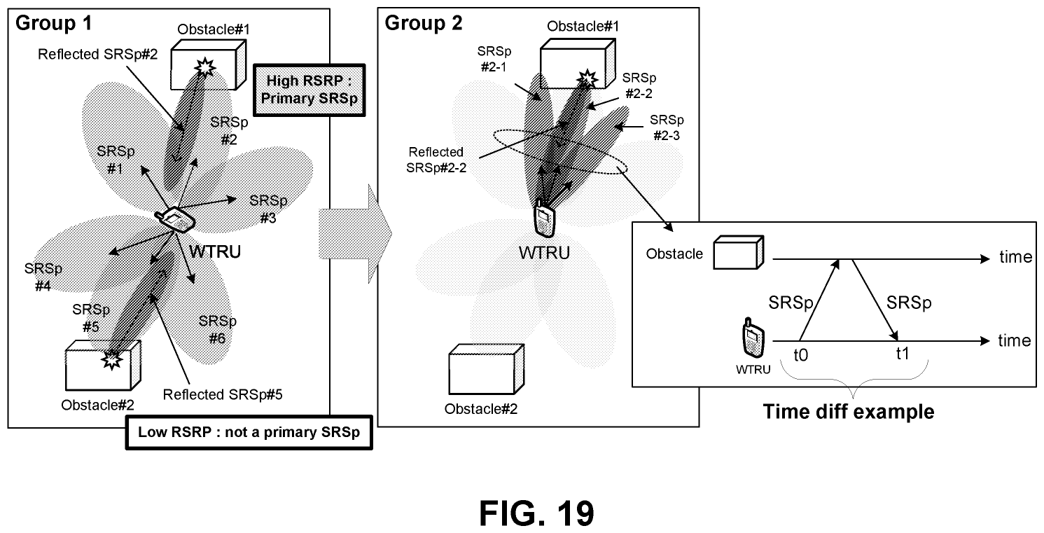

FIG. 19 shows an example of detecting the presence of an obstacle. As shown in FIG. 19, actions associated with obstacle detection may include one or more of the following operations. The WTRU may receive (e.g., from LMF) configuration information indicating a first group of resources (e.g., SRSp resources) and a second group of resources, spatial association or alignment information, one or more thresholds, and/or a number of resources (e.g., N). The WTRU may transmit a first SRSp using a resource (e.g., SRSp #2) of the first group of resources. If the WTRU receives (e.g., performs a measurement associated with) a second SRSp corresponding to the first SRSp (e.g., the second SRSp may be a reflected signal of the first SRSp due to an obstacle), and the WTRU determines that a first measurement (e.g., RSRP) of the second SRSp is above a configured threshold), the WTRU may transmit at least a third SRSp using a resource of the second group of resources (e.g., from a subset of N configured resources in the second group). The third SRSp and/or the resources used to transmit the third SRSp may be determined, for example, based on the spatial association information received by the WTRU (e.g., which may indicate a relationship or correspondence between one or more resources from the first group of SRSp resources and one or more resources from the second group of SRSp resources). The WTRU may receive (e.g., perform a measurement associated with) at least a fourth SRSp corresponding to the third SRSp (e.g., the fourth SRSp may be a reflected signal of the third SPSp due to the obstacle). The WTRU may perform the measurements, for example, by measuring at least the second and/or fourth SRSp (e.g., regarding an RSRP, a time difference, etc.), and may send a report including one or more of the following: a measurement (e.g., RSRP and/or time measurement) associated with the second SRSp or a measurement (e.g., RSRP and/or time measurement) associated with the fourth SRSp.

As described herein, the configuration information received by the WTRU may indicate multiple (e.g., two) groups of SRSp resources, spatial association information of the SRSp resources in the groups, one or more thresholds (e.g., RSRP and/or time related thresholds), and/or a number of resources N that the WTRU may select from the second group of resources described herein. As shown in FIG. 19, one or more of the SRSp resources (e.g., six SRSp resources) in the first group may be related to one or more of the SRSp resources (e.g, three SRSp resources) in the second group, and the relationship may be indicated by the spatial information received by the WTRU. For example, as shown in FIG. 19, SRSp resource #2-1, SRSp resource #2-2, and SRSp resource #2-3 may be related spatially to SRSp resource #2 (e.g., the transmission spatial filter for SRSp resource #2-1 may be within a preconfigured angle with respect to the transmission spatial filter for SRSp resource #2).

If the WTRU receives the second SRSp corresponding to the first SRSp (e.g., the second SRSp may be a reflection of the first SRSp from an obstacle), as describe herein, the WTRU may perform a correlation analysis and/or a peak detection between the received signal and an SRSp sequence (e.g., which may be transmitted prior to receiving the reflected signal) in a time and/or frequency domain. In an example, the SRSp sequence may include a sequence of complex values (e.g., N complex numbers) that may be placed across resource elements in the frequency domain. In another example, the SRSp sequence may include a sequence of complex values that may be placed across OFDM or DFTsOFDM symbols/samples the time domain. The correlation analysis (e.g., performed using a correlator component of the WTRU) may indicate that the second (e.g., reflected) SRSp has the same or substantially similar time and/or frequency signal characteristics (e.g., with respect to a comb pattern, a signal pattern across the time domain, a periodicity, a time duration, a bandwidth, a center frequency, and/or the like) as the first SRSp (e.g., a correlation value calculated based on one or more of the aforementioned characteristics is above a preconfigured threshold), and the WTRU may determine that the first SRSp and second SRSp are the same (e.g., or that the second SRSp is the first SRSp reflected from the obstacle) based on the indication. The WTRU may repeat the techniques described herein (e.g., transmitting an SRSp resource and detecting/analyzing a reflection of the transmitted SRSp by performing the correlation analysis) for one or more (e.g., all) of the SRSps resources in the first group.

In examples, if the RSRP of the reflected SRSp is above a configured threshold, the WTRU may consider the transmitted SRSp a primary SRSp. For such a primary SRSp (e.g., for each primary SRSp), the WTRU may determine a subset of N SRSp resources from the second group of SRSp resources that may be spatially related to the primary SRSp, for example, based on the configured spatial information (e.g., which may indicate the SRSp resource ID(s) with which the primary SRSp resource is aligned spatially, the relative angles of the SRSp resources, etc.). In examples, if the second group of SRSp resources includes more than N SRSp resources that may have the same spatial relationship as the primary SRSp, the WTRU may choose the N SRSp resources based on one or more of the following: based on an increasing or decreasing order of SRSp resource IDs, starting from the highest or lowest SRSp resource ID; based on one or more priorities indicated by the network (e.g., the WTRU may receive a list of SRSp resource indices or IDs ordered based on priorities what the WTRU may use when selecting SRSp resources from the second group); etc.

The measurements described herein may include RSRP measurements and/or or time measurements (e.g., the time difference between transmission of the first SRSp and reception of the second SRSp) associated with the SRSps. The WTRU may transmit the third SRSp using the group of N SRSp resources, and if the WTRU receives a reflected SRSp (e.g., fourth SRSp) corresponding to the third SRSp, the WTRU may determine if the received SRSp is a reflected version of the third SRSp, for example, by performing the correlation analysis described herein. If the RSRP of the reflected SRSp is above the threshold, the WTRU may determine that the received SRSp (or the corresponding transmitted SRSp) is a primary SRSp.

The WTRU may be configured with multiple thresholds, where a threshold (e.g., each threshold) may correspond to a group of SRSp resources. For example, the groups of SRSp resources may be associated with different beamwidths and/or frequency ranges. In such a case, the RSRP values corresponding to different beamwidths may be different. The WTRU may receive different values of RSRP thresholds from the network for the groups of SRSp resources having different beamwidths. For a primary SRSp (e.g., for each primary SRSp) in the first and/or second group described herein, the WTRU may report RSRP and/or time difference measurements (e.g., an example of the time difference may be shown in FIG. 19 and FIG. 9). The measurements may include an RSRP measurement of the fourth SRSp, a time difference between the transmission of the third SRSp and the reception of the fourth SRSp, etc.

The WTRU may be configured with a time window during which the WTRU may monitor for a reflected SRSp. The time window may start, for example, after the WTRU completes transmission of an SRSp and the WTRU may monitor whether the WTRU receives a reflected version of the transmitted SRSp during the time window. The time window may be indicated by start and end times, and/or a duration (e.g., expressed in number of symbols, slots, frames, or seconds). The time window may be indicated by downlink and/or flexible slots or symbols in a TDD format. If the WTRU does not receive a reflected SRSp during the time window, the WTRU may stop monitoring and may transmit the next SRSp in the same group of SRSp resources.

It should be noted that reference signals that may be used in the examples described herein (e.g., for sensing) may not be limited to an SRSp. The term SRSp may be interchangeably used with other types of references signals including, e.g., a CSI-RS, a PRS, an SRS, a sidelink PRS, etc.

An association between an obstacle and one or more primary SRSps may be established. As described herein, the WTRU may transmit SRSps using multiple groups of SRSp resources and may measure reflected SRSp(s) to estimate the location of an obstacle. For the groups of resources (e.g., for each of the groups of resources), the WTRU may determine one or more primary SRSps. The groups of SRSp resources may be associated with different beamwidths, center frequencies, bandwidths, and/or frequency ranges. The WTRU may determine the location of the obstacle based on one or more measurements (e.g., RSRP and/or time difference) performed the primary SRSps (e.g., for each primary SRSp). The WTRU may report detailed information about the obstacle (e.g., dimension of the obstacle, shape of the obstacle, etc.) to the network by associating location information related to the same obstacle with each other. For example, the WTRU may determine and/or report relative location information (e.g., relative to primary location information) based on the spatial relationship of the primary SRSps. The primary location of the obstacle may be expressed as an absolute position (e.g., expressed in terms of global/local coordinates), and the relative location of the obstacle may be expressed as a location relative to the location of the WTRU (e.g., determined based on differences in the coordinates of the two entities). The WTRU may determine and/or report the primary location or relative location in accordance with an indication received from the network. In examples, the WTRU may determine the primary location of the obstacle based on measurements (e.g., RSRP, AoD, AoA, and/or time difference) corresponding to a first primary SRSp in a first group of SRSp resources. If the WTRU determines a second primary SRSp in a second group of SRSp resources that may be spatially associated with the first primary SRSp, the WTRU may determine a second location of the obstacle based on the measurements corresponding to the second primary SRSp. The second location may be expressed as a relative location with respect to the primary location. If the WTRU determines a third primary SRSp in the second group of resources, the WTRU may determine a relative location with respect to the primary location based on measurements of that primary SRSp. The WTRU may repeat the techniques described herein for the primary SRSp(s) in a third group, where the location information associated with the primary SRSp may be expressed as a relative location with respect to the primary location. In examples, the WTRU may receive an indication from the network to report relative (e.g., differential) and/or primary locations to the network if the WTRU determines more than one primary SRSp. In examples, the WTRU may determine, without receiving an indication from the network, to report relative (e.g., differential) and/or primary locations to the network if the WTRU determines more than one primary SRSp.

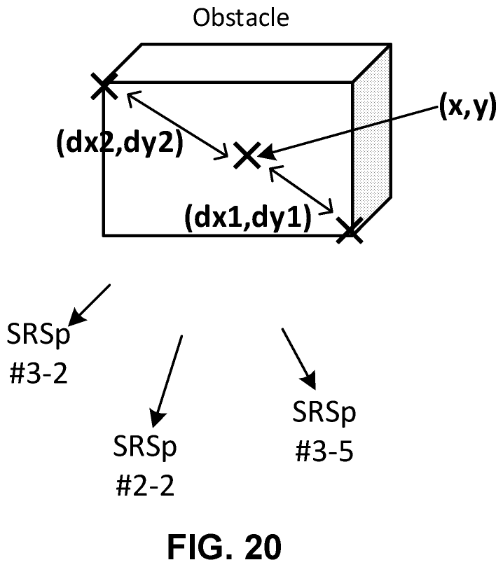

FIG. 20 shows an example of an association of a primary obstacle location and one or more relative (e.g., differential) locations. As shown, the WTRU may determine the primary location (x,y) of the obstacle based on the measurements corresponding to SRSp #2-2, which may be a first primary SRSp. The WTRU may perform obstacle positioning using a second group of SRSp resources, which may be spatially related to SRSp #2-2, and the WTRU may determine second and third primary SRSps, SRSp #3-2 and SRSp #3-5, respectively. The WTRU may obtain location information associated with SRSps through obstacle positioning. The obstacle positioning may be angle-based or RTT-based. If angle-based positioning is used, the WTRU may determine the location of the obstacle based on the RSRP of a received SRSp, an SRSp resource ID, an angle of arrival of the received (e.g., reflected) SRSp, and/or an angle of departure of the SRSp. If RTT-based positioning is used, the WTRU may determine the location of the obstacle based on a time difference, e.g., as shown in FIG. 19. In examples, the WTRU may determine an absolute location (e.g., the primary location described herein) of the obstacle and/or a location associated with an SRSp based on measurements and/or the absolute location of the WTRU. For example, the RTT-based positioning technique may infer the distance between the obstacle and the WTRU. Based on the angle of departure of an SRSp, an angle of arrival of a reflected SRSp, the distance information, and/or the absolute location of the WTRU, the WTRU may determine the absolute location of the obstacle. The WTRU may determine the relative location of the obstacle with respect to the WTRU, for example, if the WTRU does not have information about or cannot determine the absolute location of the WTRU. The absolute location of the WTRU may be provided by the network or may be determined by the WTRU using a RAT-dependent (e.g., DL-TDOA, DL-AoD) or RAT-independent positioning method (e.g., GNSS based positioning). Based on the measurements made on SRSp #3-2 and SRSp #3-5, the WTRU may determine the corresponding relative location information with respect to the primary location (x,y). As shown in FIG. 20, the relative location information corresponding to SRSp #3-2 and SRSp #3-5 may be expressed as (dx2, dy2) and (dx1, dy1), respectively, while the absolute location associated with SRSp #3-2 and SRSp #3-5 may be expressed as (x+dx2, y+dy2) and (x+dx1, y+dy1), respectively. If the WTRU terminates sensing, the WTRU may report the primary (e.g., absolute) location and/or the relative location(s) with respect to the primary location to the network (e.g., LMF and/or gNB). If the WTRU determines that there are multiple obstacles (e.g., multiple primary locations), the WTRU may report multiple primary locations and relative locations associated with the primary locations (e.g., with each of the primary locations).

Although features and elements described above are described in particular combinations, each feature or element may be used alone without the other features and elements of the preferred embodiments, or in various combinations with or without other features and elements. Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well. The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A wireless transmit receive unit (WTRU), comprising:
a processor configured to:
receive configuration information, wherein the configuration information indicates a first group of resources;
transmit a first sounding reference signal for positioning (SRSp) using a first resource from the first group of resources;
perform a first measurement associated with a first reflected signal of the first SRSp; and
based on a determination that a result of the first measurement meets a first condition, transmit an indication of the result of the first measurement to a network device.

2. The WTRU of claim 1, wherein the configuration information further indicates a second group of resources and a relationship between the first resource and one or more resources from the second group of resources, and wherein, based on the determination that the result of the first measurement meets the first condition, the processor is further configured to:
select a second resource from the second group of resources based on the first resource and the relationship between the first resource and the one or more resources from the second group of resources; and
transmit a second SRSp using the second resource selected from the second group of resources.

3. The WTRU of claim 2, the processor is further configured to:
perform a second measurement associated with a second reflected signal of the second SRSp; and
based on a determination that a result of the second measurement meets a second condition, report an indication of the result of the second measurement to the network device.

4. The WTRU of claim 3, wherein the second measurement includes a reference signal received power (RSRP) measurement associated with the second reflected signal, and wherein the result of the second measurement is determined to meet the second condition based on a determination that the RSRP measurement exceeds a threshold value.

5. The WTRU of claim 3, wherein the processor is further configured to determine a time delay between the transmission of the second SRSp and the reception of the second reflected signal, the processor further configured to report the time delay to the network device.

6. The WTRU of claim 2, wherein the first group of resources is associated with beams of a first beamwidth, wherein the second group of resources is associated with beams of a second beamwidth, and wherein the first beamwidth is wider than the second beamwidth.

7. The WTRU of claim 1, wherein the first measurement includes a reference signal received power (RSRP) measurement, and wherein the result of the first measurement is determined to meet the first condition based on a determination that the RSRP measurement exceeds a threshold value.

8. The WTRU of claim 1, wherein the processor is further configured to determine a time delay between the transmission of the first SRSp and the reception of the first reflected signal, the processor further configured to report the time delay to the network device.

9. The WTRU of claim 1, wherein the processor is further configured to:
receive a positioning reference signal (PRS) from the network device;
determine whether a second resource from the first group of resources is spatially aligned with the PRS; and
based on a determination that no resource from the first group of resources is spatially aligned with the PRS, send a request to the network device for an SRSp resource that is spatially aligned with the PRS.

10. The WTRU of claim 9, wherein whether the second resource is spatially aligned with the PRS is determined based on an angle of arrival of the PRS and a boresight angle of the second resource.

11. The WTRU of claim 1, wherein the first group of resources is associated with SRSp transmissions.

12. A method implemented by a wireless transmit receive unit (WTRU), the method comprising:
receiving configuration information, wherein the configuration information indicates a first group of resources;
transmitting a first sounding reference signal for positioning (SRSp) using a first resource from the first group of resources;
performing a first measurement associated with a first reflected signal of the first SRSp; and
based on a determination that a result of the first measurement meets a first condition, transmitting an indication of the result of the first measurement to a network device.

13. The method of claim 12, wherein the configuration information further indicates a second group of resources and a relationship between the first resource and one or more resources from the second group of resources, and wherein the method further comprising, based on the determination that the result of the first measurement meets the first condition:
selecting a second resource from the second group of resources based on the first resource and the relationship between the first resource and the one or more resources from the second group of resources; and
transmitting a second SRSp using the second resource selected from the second group of resources.

14. The method of claim 13, wherein the method further comprising:
performing a second measurement associated with a second reflected signal of the second SRSp; and
based on a determination that a result of the second measurement meets a second condition, reporting an indication of the result of the second measurement to the network device.

15. The method of claim 14, wherein the first measurement and the second measurement include a first reference signal received power (RSRP) measurement and a second RSRP measurement, respectively, wherein the result of the first measurement is determined to meet the first condition based on a determination that the first RSRP measurement exceeds a first threshold value, and wherein the result of the second measurement is determined to meet the second condition based on a determination that the second RSRP measurement exceeds a second threshold value.

16. The method of claim 14, further comprising:
determining a first time delay between the transmission of the first SRSp and the reception of the first reflected signal;
determining a second time delay between the transmission of the second SRSp and the reception of the second reflected signal; and
reporting the first time delay and the second time delay to the network device.

17. The method of claim 13, wherein the first group of resources is associated with beams of a first beamwidth, the second group of resources is associated with beams of a second beamwidth, and the first beamwidth is wider than the second beamwidth.

18-20. (canceled)

21. The method of claim 12, further comprising:
receiving a positioning reference signal (PRS) from the network device;
determining whether a second resource from the first group of resources is spatially aligned with the PRS; and
based on a determination that no resource from the first group of resources is spatially aligned with the PRS, sending a request to the network device for an SRSp resource that is spatially aligned with the PRS.

22. A network device, comprising:
a processor configured to:
receive information from a wireless transmit receive unit (WTRU), wherein the information indicates a measurement associated with a reflected signal of a sounding reference signal for positioning (SPSp);
determine a presence or non-presence of an obstacle between the network device and the WTRU based on the information received from the WTRU; and
allocate a resource for the WTRU based on the presence or non-presence of the obstacle.

23. The network device of claim 22, wherein the information received from the WTRU indicates a reference signal received power (RSRP) associated with the reflected signal of the SPSp.
